(19) United States
(12) Patent Application Publication
(10) Pub. No.: US 2024/0147385 A1
(43) Pub. Date: May 2, 2024

(54) POWER HEADROOM REPORTING FOR UPLINK CHANNEL REPETITION

(71) Applicant: QUALCOMM Incorporated, San Diego, CA (US)

(72) Inventors: Ruiming ZHENG, Beijing (CN); Mostafa KHOSHNEVISAN, San Diego, CA (US); Linhai HE, San Diego, CA (US)

(21) Appl. No.: 18/569,065

(22) PCT Filed: Aug. 13, 2021
(86) PCT No.: PCT/CN2021/112476

§ 371 Date: Dec. 11, 2023

(51) Int. Cl. H04W 52/36; H04W 72/1268

(52) U.S. Cl. CPC H04W 52/365; H04W 72/1268

(57) ABSTRACT

Certain aspects of the present disclosure provide techniques for wireless communications by a user equipment (UE) includes receiving a plurality of power headroom report (PHR) configurations, where each of the plurality of PHR configurations is associated with a different communication configuration of a plurality of communication configurations of the UE; and transmitting one or more PHRs based on the plurality of PHR configurations.

### INTRODUCTION

Aspects of the present disclosure relate to wireless communications, and more particularly, to techniques for power headroom reporting.

Wireless communication systems are widely deployed to provide various telecommunication services such as telephony, video, data, messaging, broadcasts, or other similar types of services. These wireless communication systems may employ multiple-access technologies capable of supporting communication with multiple users by sharing available system resources with those users (e.g., bandwidth, transmit power, or other resources). Multiple-access technologies can rely on any of code division, time division, frequency division orthogonal frequency division, single-carrier frequency division, or time division synchronous code division, to name a few. These and other multiple access technologies have been adopted in various telecommunication standards to provide a common protocol that enables different wireless devices to communicate on a municipal, national, regional, and even global level.

Although wireless communication systems have made great technological advancements over many years, challenges still exist. For example, complex and dynamic environments can still attenuate or block signals between wireless transmitters and wireless receivers, undermining various established wireless channel measuring and reporting mechanisms, which are used to manage and optimize the use of finite wireless channel resources. Consequently, there exists a need for further improvements in wireless communications systems to overcome various challenges.

### SUMMARY

In one aspect, a method for wireless communications by a user equipment (UE) includes receiving a plurality of power headroom report (PHR) configurations, where each of the plurality of PHR configurations is associated with a different communication configuration of a plurality of communication configurations of the UE; and transmitting one or more PHRs based on the plurality of PHR configurations.

In one aspect, a method for wireless communications by a base station (BS) includes transmitting a plurality of PHR configurations, where each of the plurality of PHR configurations is associated with a different communication configuration of a plurality of communication configurations of a UE; and receiving one or more PHRs based on the plurality of PHR configurations.

In one aspect, a UE comprises a memory and a processor coupled to the memory, the processor and the memory configured to receive a plurality of PHR configurations, where each of the plurality of PHR configurations is associated with a different communication configuration of a plurality of communication configurations of the UE; and transmit one or more PHRs based on the plurality of PHR configurations.

In one aspect, a BS comprises a memory and a processor coupled to the memory, the processor and the memory configured to transmit a plurality of PHR configurations, where each of the plurality of PHR configurations is associated with a different communication configuration of a plurality of communication configurations of a UE; and receive one or more PHRs based on the plurality of PHR configurations.

In one aspect, non-transitory computer readable storage medium comprises instructions that, when executed by one or more processors of a UE, cause the UE to receive a plurality of PHR configurations, where each of the plurality of PHR configurations is associated with a different communication configuration of a plurality of communication configurations of the UE; and transmit one or more PHRs based on the plurality of PHR configurations.

In one aspect, non-transitory computer readable storage medium comprises instructions that, when executed by one or more processors of a BS, cause the BS to transmit a plurality of PHR configurations, where each of the plurality of PHR configurations is associated with a different communication configuration of a plurality of communication configurations of a UE; and receive one or more PHRs based on the plurality of PHR configurations.

In one aspect, a UE comprises means for receiving a plurality of PHR configurations, where each of the plurality of PHR configurations is associated with a different communication configuration of a plurality of communication configurations of the UE; and means for transmitting one or more PHRs based on the plurality of PHR configurations.

In one aspect, a BS comprises means for transmitting a plurality of PHR configurations, where each of the plurality of PHR configurations is associated with a different communication configuration of a plurality of communication configurations of a UE; and means for receiving one or more PHRs based on the plurality of PHR configurations.

Other aspects provide: an apparatus operable, configured, or otherwise adapted to perform the aforementioned methods as well as those described elsewhere herein; a non-transitory, computer-readable media comprising instructions that, when executed by one or more processors of an apparatus, cause the apparatus to perform the aforementioned methods as well as those described elsewhere herein; a computer program product embodied on a computer-readable storage medium comprising code for performing the aforementioned methods as well as those described elsewhere herein; and an apparatus comprising means for performing the aforementioned methods as well as those described elsewhere herein. By way of example, an apparatus may comprise a processing system, a device with a processing system, or processing systems cooperating over one or more networks.

The following description and the appended figures set forth certain features for purposes of illustration.

### BRIEF DESCRIPTION OF THE DRAWINGS

The appended figures depict certain features of the various aspects described herein and are not to be considered limiting of the scope of this disclosure.

FIG. 1 is a block diagram conceptually illustrating an example wireless communication network.

FIG. 2 is a block diagram conceptually illustrating aspects of an example of a base station and user equipment.

FIGS. 3A-3D depict various example aspects of data structures for a wireless communication network.

FIG. 4 depicts an example scenario for communication between a user equipment (UE) and multiple transmission reception points (TRPs).

FIG. 5 depicts an example of uplink channel repetition of a transport block across multiple cells and multiple time periods.

FIG. 6A depicts an example of power headroom report (PHR) configuration for multiple TRPs.

FIG. 6B depicts an example of power headroom report (PHR) configuration for multiple cells.

FIG. 6C depicts an example of power headroom report (PHR) configuration for multiple TRP and cell combinations.

FIG. 7 depicts an example single entry PHR medium access control (MAC) control element (CE).

FIG. 8 depicts an example multiple entry PHR MAC CE.

FIG. 9 depicts an example multiple entry PHR MAC CE with multiple PHR per cell.

FIGS. 10 and 11 show example methods for power headroom reporting for uplink channel repetition according to aspects of the present disclosure.

FIGS. 12 and 13 show examples of a communications device according to aspects of the present disclosure.

### DETAILED DESCRIPTION

Aspects of the present disclosure provide apparatuses, methods, processing systems, and computer-readable mediums for power headroom reporting. In certain aspects, techniques are provided for power headroom reporting in scenarios with uplink channel repetition (e.g., physical uplink shared channel (PUSCH) repetition).

In certain aspects, a UE is configured to transmit data to a wireless communication network on an uplink channel, such as a PUSCH, using repetition. For example, the UE may multiplex data into one or more transport blocks (TBs) and transmit the TBs on the PUSCH, such as in a time and frequency resource that may be referred to as a PUSCH resource or PUSCH occasion. The UE may further use PUSCH repetition to transmit the same TB multiple times. Such PUSCH repetition provides greater reliability that the TB is successfully received and decoded at the network.

In certain aspects, the UE is further configured to communicate with the wireless communication network using multiple transmission reception points (TRPs). Each TRP may itself be a base station (BS), or each TRP may be a radio head (RH) for a base station, where a BS may have multiple RHs. In certain aspects, the UE implements PUSCH repetition by transmitting the same TB to the wireless communication network multiple times by transmitting the same TB one or more times to each of multiple TRPs of the wireless communication network. Such a communication scenario may be referred to as multi-TRP PUSCH repetition.

In certain aspects, a UE is configured to send a power headroom report (PHR) to the wireless communication network, such as by sending the PHR to a BS of the wireless communication network. In certain aspects, the PHR generally indicates an amount of transmission power left or available at the UE. In certain aspects, the amount of transmission power left is the difference between the maximum UE transmit power and a current UE transmit power being used to transmit, such as to transmit one or more PUSCH on one or more cells to one or more TRPs. In certain aspects, the amount of transmission power left is the difference between the maximum UE transmit power and a calculated UE transmit power assuming the UE were to transmit according to a scheduling grant (e.g., uplink grant), such as to transmit one or more scheduled PUSCH on one or more cells to one or more TRPs.

A cell may be (e.g., uniquely) identified by a cell ID. A cell may refer to a set of frequency resources used for communication, such as with a BS or TRP. In certain aspects, a BS or TRP may support a single cell, such as on a primary frequency. In certain aspects, a BS or TRP may support multiple cells, such as a first cell on a primary frequency and a second cell on a secondary frequency. In certain aspects, a “serving cell” refers to the primary cell, such as when carrier aggregation (CA) is not configured. In certain aspects, a “serving cell” refers to one or more cells, such as when CA is configured. In certain aspects, multiple TRPs may serve a single cell.

In certain aspects, such as in multi-TRP PUSCH repetition scenarios, different sets of power control parameters (e.g., p0, alpha, path loss (PL) reference signal (RS), closed loop index, etc.) and/or different power control loops may be used to control UE transmit power for transmission of PUSCH to different TRPs. Accordingly, PHR calculation at the UE for the different TRPs may be different.

Accordingly, separate PHR reporting by a UE for different TRPs, such as in multi-TRP PUSCH repetition scenarios, may be useful, such as to provide separate PHR calculations for the different TRPs.

Certain aspects herein enable such separate PHR reporting by a UE for different TRPs. For example, certain aspects herein provide techniques related to configuring separate PHR configurations, such as uplink power control parameters and/or PHR triggering parameters, at a UE for different communication configurations. A communication configuration may refer, for example, to a particular TRP, a particular cell, a particular combination of TRP and cell, or the like as further discussed herein. Certain aspects provide techniques related to PHR triggering, meaning triggering transmission of PHR, for a UE configured with multiple PHR configurations. Certain aspects provide techniques related to PHR reporting format for multi-TRP PUSCH repetition.

Such techniques allow for separate PHR reporting for different TRPs, which may provide for separate power control at the UE for the different TRPs, which may help to save power consumption at the UE when the transmit power is reduced, or may help to improve reliability of uplink transmissions when the transmit power is increased.

Though certain aspects are described herein as related to communication by the UE with multiple TRPs, it should be noted that communication with multiple TRPs may be referred to in different manners. For example, each TRP may be represented by a corresponding configuration option, such as a corresponding sounding reference signal (SRS) resource set, a corresponding power control parameter set, or a corresponding transmit beam of the UE used for communication with the TRP. A SRS resource set may refer to a set of resources (e.g., time-frequency resources) used by the UE to transmit SRS to a TRP. A power control parameter set may refer to uplink power control parameters used for uplink power control of transmissions to a TRP. For example, a first TRP and a second TRP may be referred to instead by a first SRS resource set and a second SRS resource set, respectively. In another example, a first TRP and a second TRP may be referred to instead by a first power control parameter set and a second power control parameter set, respectively. In another example, a first TRP and a second TRP may be referred to instead by a first UE transmit beam and a second UE transmit beam, respectively. Accordingly, a communication configuration described as referring to a particular TRP, for example, may refer to a particular sounding reference signal (SRS) resource set, a particular power control parameter set, or a particular transmit beam of the UE.

### Introduction to Wireless Communication Networks

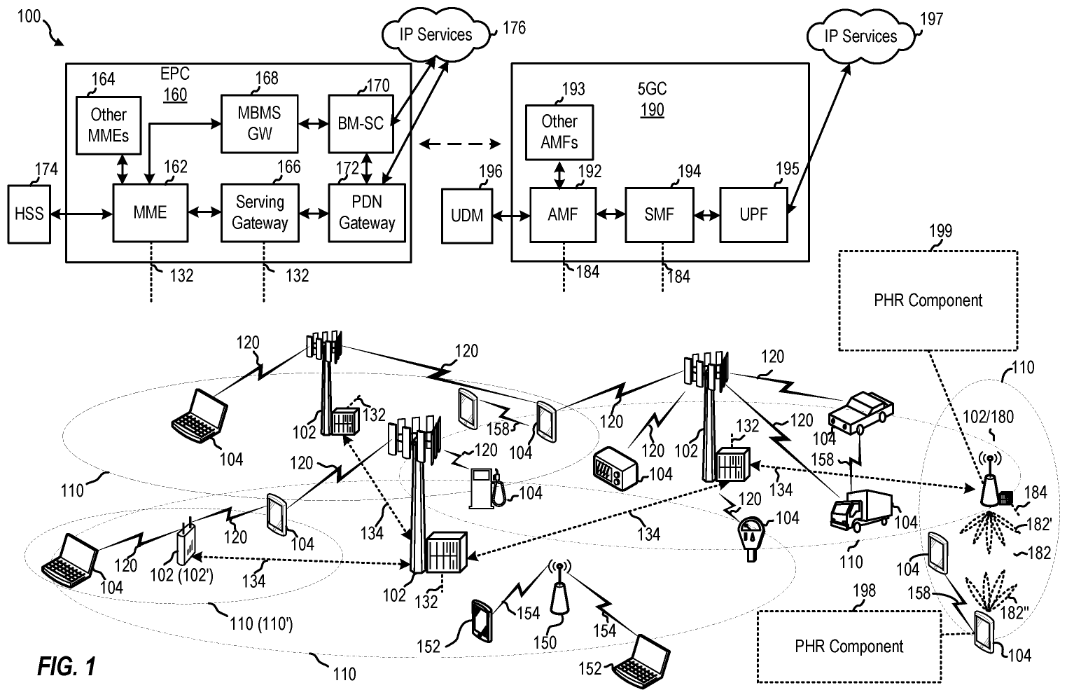

FIG. 1 depicts an example of a wireless communications system 100, in which aspects described herein may be implemented.

Generally, wireless communications system 100 includes base stations (BSs) 102, user equipments (UEs) 104, one or more core networks, such as an Evolved Packet Core (EPC) 160 and 5G Core (5GC) network 190, which interoperate to provide wireless communications services.

Base stations 102 may provide an access point to the EPC 160 and/or 5GC 190 for a user equipment 104, and may perform one or more of the following functions: transfer of user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, radio access network (RAN) sharing, multimedia broadcast multicast service (MBMS), subscriber and equipment trace, RAN information management (RIM), paging, positioning, delivery of warning messages, among other functions. Base stations may include and/or be referred to as a gNB, NodeB, eNB, ng-eNB (e.g., an eNB that has been enhanced to provide connection to both EPC 160 and 5GC 190), an access point, a base transceiver station, a radio base station, a radio transceiver, or a transceiver function, or a transmission reception point in various contexts.

Base stations 102 wirelessly communicate with UEs 104 via communications links 120. Each of base stations 102 may provide communication coverage for a respective geographic coverage area 110, which may overlap in some cases. For example, small cell 102′ (e.g., a low-power base station) may have a coverage area 110′ that overlaps the coverage area 110 of one or more macrocells (e.g., high-power base stations).

The communication links 120 between base stations 102 and UEs 104 may include uplink (UL) (also referred to as reverse link) transmissions from a user equipment 104 to a base station 102 and/or downlink (DL) (also referred to as forward link) transmissions from a base station 102 to a user equipment 104. The communication links 120 may use multiple-input and multiple-output (MIMO) antenna technology, including spatial multiplexing, beamforming, and/or transmit diversity in various aspects.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player, a camera, a game console, a tablet, a smart device, a wearable device, a vehicle, an electric meter, a gas pump, a large or small kitchen appliance, a healthcare device, an implant, a sensor/actuator, a display, or other similar devices. Some of UEs 104 may be internet of things (IoT) devices (e.g., parking meter, gas pump, toaster, vehicles, heart monitor, or other IoT devices), always on (AON) devices, or edge processing devices. UEs 104 may also be referred to more generally as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, or a client.

Communications using higher frequency bands may have higher path loss and a shorter range compared to lower frequency communications. Accordingly, certain base stations (e.g., 180 in FIG. 1) may utilize beamforming 182 with a UE 104 to improve path loss and range. For example, base station 180 and the UE 104 may each include a plurality of antennas, such as antenna elements, antenna panels, and/or antenna arrays to facilitate the beamforming.

In some cases, base station 180 may transmit a beamformed signal to UE 104 in one or more transmit directions 182′. UE 104 may receive the beamformed signal from the base station 180 in one or more receive directions 182″. UE 104 may also transmit a beamformed signal to the base station 180 in one or more transmit directions 182″. Base station 180 may also receive the beamformed signal from UE 104 in one or more receive directions 182′. Base station 180 and UE 104 may then perform beam training to determine the best receive and transmit directions for each of base station 180 and UE 104. Notably, the transmit and receive directions for base station 180 may or may not be the same. Similarly, the transmit and receive directions for UE 104 may or may not be the same.

Wireless communication network 100 includes PHR component 199, which may be configured to transmit PHR configurations and/or receive PHR. Wireless network 100 further includes PHR component 198, which may be used configured to receive multiple PHR configurations, trigger reporting of PHR based on multiple PHR configurations, and/or report PHR for multiple cells and/or TRPs.

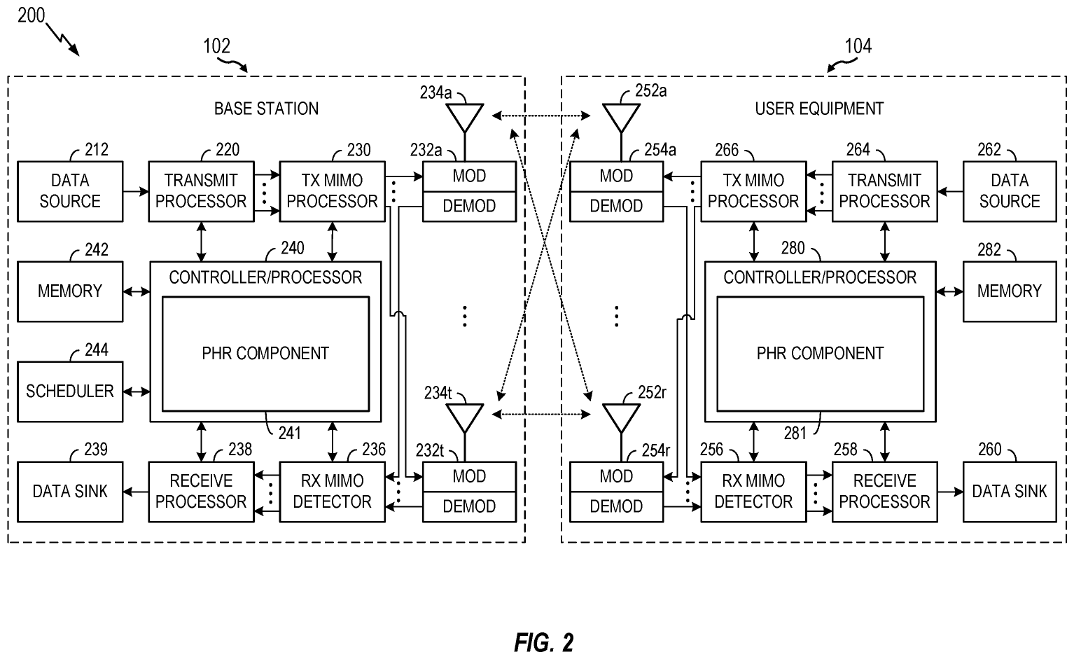

FIG. 2 depicts aspects of an example base station (BS) 102 and a user equipment (UE) 104.

Generally, base station 102 includes various processors (e.g., 220, 230, 238, and 240), antennas 234a-t (collectively 234), transceivers 232a-t (collectively 232), which include modulators and demodulators, and other aspects, which enable wireless transmission of data (e.g., data source 212) and wireless reception of data (e.g., data sink 239). For example, base station 102 may send and receive data between itself and user equipment 104.

Base station 102 includes controller/processor 240, which may be configured to implement various functions related to wireless communications. In the depicted example, controller/processor 240 includes PHR component 241, which may be representative of PHR component 199 of FIG. 1. Notably, while depicted as an aspect of controller/processor 240, PHR component 241 may be implemented additionally or alternatively in various other aspects of base station 102 in other implementations.

Generally, user equipment 104 includes various processors (e.g., 258, 264, 266, and 280), antennas 252a-r (collectively 252), transceivers 254a-r (collectively 254), which include modulators and demodulators, and other aspects, which enable wireless transmission of data (e.g., data source 262) and wireless reception of data (e.g., data sink 260).

User equipment 104 includes controller/processor 280, which may be configured to implement various functions related to wireless communications. In the depicted example, controller/processor 280 includes PHR component 281, which may be representative of PHR component 198 of FIG. 1. Notably, while depicted as an aspect of controller/processor 280, PHR component 281 may be implemented additionally or alternatively in various other aspects of user equipment 104 in other implementations.

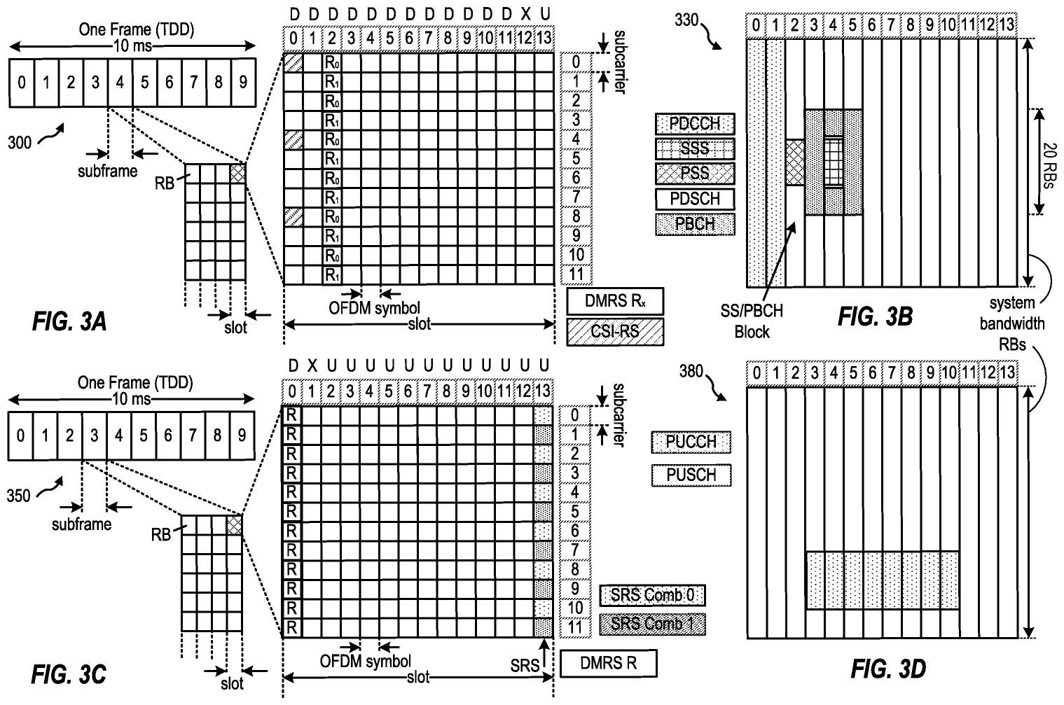

FIGS. 3A-3D depict aspects of data structures for a wireless communication network, such as wireless communication network 100 of FIG. 1. In particular, FIG. 3A is a diagram 300 illustrating an example of a first subframe within a 5G (e.g., 5G NR) frame structure, FIG. 3B is a diagram 330 illustrating an example of DL channels within a 5G subframe, FIG. 3C is a diagram 350 illustrating an example of a second subframe within a 5G frame structure, and FIG. 3D is a diagram 380 illustrating an example of UL channels within a 5G subframe.

Further discussions regarding FIG. 1, FIG. 2, and FIGS. 3A-3D are provided later in this disclosure.

### Aspects Related to Multi-TRP Operation

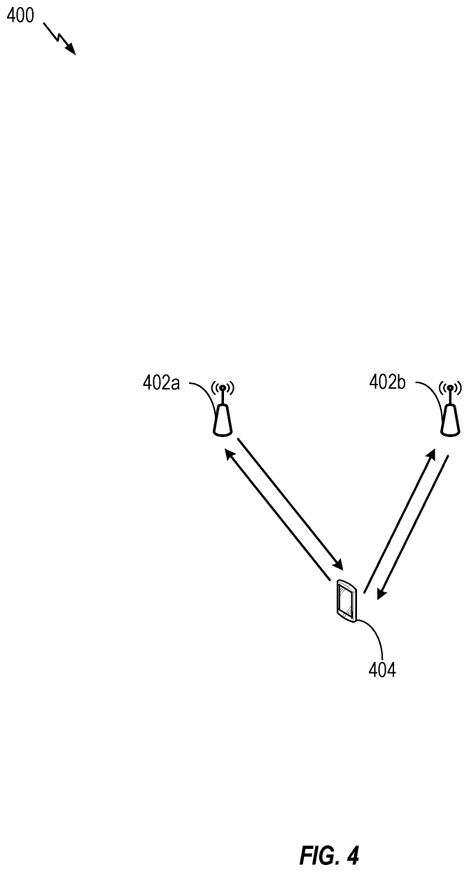

FIG. 4 depicts a scenario 400 for communication between UE 404 (e.g., corresponding to UE 104 of FIG. 1) and multiple TRPs 402a and 402b (e.g., corresponding to BS 102 of FIG. 1). Though UE 404 is shown as only communicating with two TRPs, it should be noted that the techniques discussed herein may also be used for the UE 404 communicating with more than two TRPs.

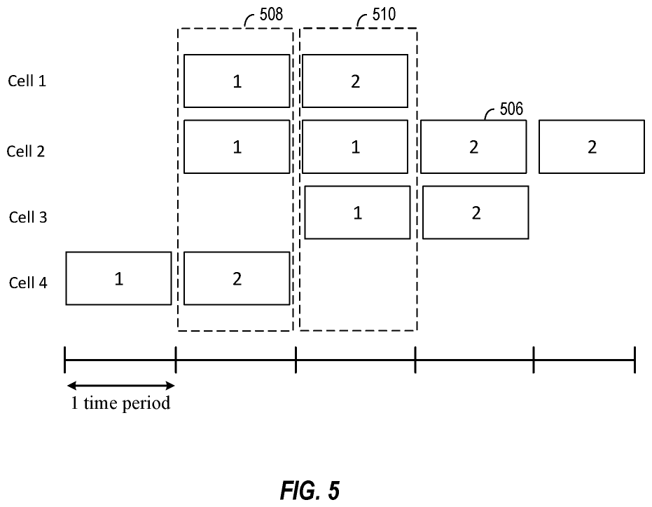

As shown, the UE 404 is configured to transmit on uplinks to both TRP 402a and TRP 402b. For example, the UE 404 transmits data (e.g., TB s) on a PUSCH to TRP 402a and transmits data on a PUSCH to TRP 402b. In certain aspects, the UE 404 may transmit one or more PHRs (e.g., in a TB carrying data) to TRP 402a and/or TRP 402b on the PUSCH. In certain aspects, both TRP 402a and TRP 402b serve the UE 404 on the same one or more cells. In certain aspects, UE 404, TRP 402a, and TRP 402b support multi-TRP PUSCH repetition, such as discussed with respect to FIG. 5. For example, in certain aspects, UE 404 repeats transmission of a TB carrying one or more PHRs (e.g., one or more PHR medium access control (MAC) control elements (CEs)) to each of TRP 402a and TRP 402b.

As shown, in certain aspects, UE 404 is further configured to receive on a downlink from TRP 402a and TRP 402b. For example, the UE 404 may be configured to receive PHR configurations for both TRP 402a and TRP 402b from TRP 402a, such as in a physical downlink shared channel (PDSCH). For example, in certain aspects, UE 404 may receive PDSCH carrying PHR configurations from only TRP 402a. In certain aspects the UE 404 may receive PHR configurations for TRP 402a and TRP 402b from TRP 402a and TRP 402b, such as respectively. For example, in certain aspects, UE 404 may receive PDSCH carrying PHR configuration(s) from both TRP 402a and TRP 402b.

In certain aspects, UE 404 may also be configured to receive downlink control information (DCI) from TRP 402a and/or TRP 402b on the PDCCH. In certain aspects, the UE 404 may also be configured to receive downlink data from TRP 402a and/or TRP 402b, such as on a physical downlink shared channel (PDSCH).

### Aspects Related to PUSCH Repetition

FIG. 5 depicts an example of PUSCH repetition of a TB across multiple cells and multiple time periods. Each transmission (e.g., PUSCH) occasion 506 shown represents a repeated transmission by UE 404 of FIG. 4 of the same TB carrying data in a PUSCH. As shown, the TB is repeatedly transmitted across different time periods (e.g., slots, mini-slots, symbols, etc.) in transmission occasions 506. Further, the TB is repeatedly transmitted in different cells 1-4 in transmission occasions 506. In addition, the number (1 or 2) as shown with respect to each transmission occasion 506 in which the TB is transmitted represents the TRP that is the intended recipient of the TB as transmitted in the transmission occasion 506. For example, the number “1” may refer to TBs transmitted in transmission occasions 506 intended for TRP 402a of FIG. 4, and the number “2” may refer to TBs transmitted in transmission occasions 506 intended for TRP 402b of FIG. 4. Though a certain number of cells, time periods, and TRPs are shown, it should be noted that the techniques discussed herein can be applied to any suitable number of cells, time periods, and TRPs.

### Aspects Related to PHR Configuration

In certain aspects, a UE 404 is configured with a plurality of PHR configurations. A PHR configuration may include a plurality of parameters used by the UE 404 to determine when to trigger transmission of a PHR. In particular, based on the plurality of parameters, the UE 404 may determine if a triggering condition is met, and if so, the UE 404 may transmit a PHR. For example, UE 404 may be configured to transmit PHR based on a number of different triggering events.

In certain aspects, UE 404 may be triggered to report PHR upon expiration of a periodic timer. In other cases, the UE 404 may be triggered to report PHR if a prohibit timer has expired (meaning PHR is not prohibited) and certain one or more conditions occur (e.g., conditions that warrant an updated report). An example of a condition includes whether path loss as measured by UE 404 since a prior measurement of path loss has changed by a threshold referred to as a path loss change threshold or a power factor change.

In certain aspects, a TRP 402 may transmit a path loss reference signal (PL RS) to the UE 404, and the UE 404 calculates path loss based on the PL RS. In certain aspects, separate TRPs (e.g., TRP 402a and TRP 402b) transmit PL RS separately, such that the UE 404 can calculate path loss separately for each of the TRPs. Accordingly, in certain aspects, PL RS may be configured separately for different TRPs, such as being communicated on different time and frequency resources.

Thus, in certain aspects, the plurality of parameters included in a PHR configuration may include a periodic timer, a prohibit timer, and a power factor change.

In certain aspects, UE 404 is configured to receive a plurality of PHR configurations via radio resource control (RRC) signaling, such as from a BS (e.g., a TRP) in a RRC message. For example, in certain aspects, the RRC message may include an information element (IE) (e.g., MAC-cellgroup IE) that includes a plurality of PHR configurations (e.g., each referenced as a phr-Config).

In certain aspects, each of the plurality of PHR configurations is associated with a different communication configuration, as discussed. For example, each of the plurality of PHR configurations may be associated with a different TRP. In another example, each of the plurality of PHR configurations may be associated with a different cell. In yet another example, each of the plurality of PHR configurations may be associated with a different TRP and cell combination.

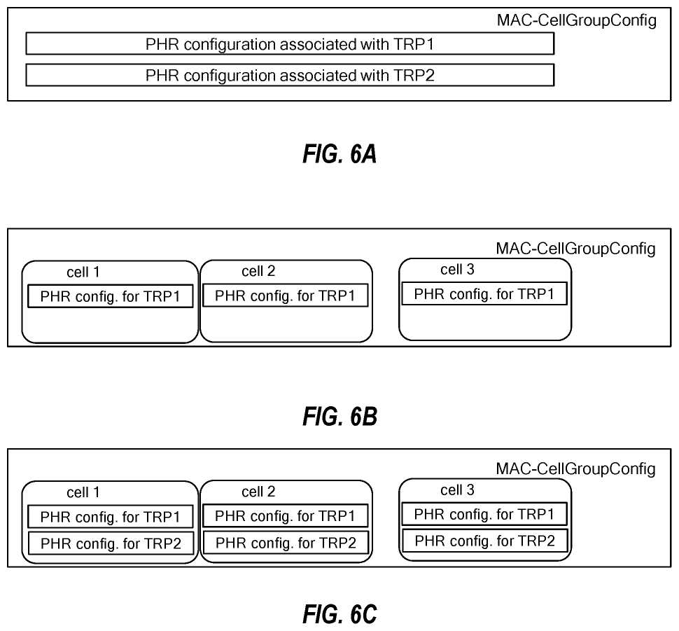

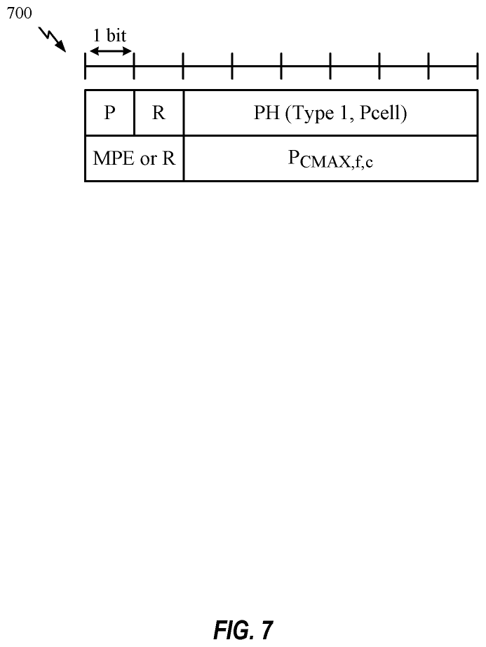

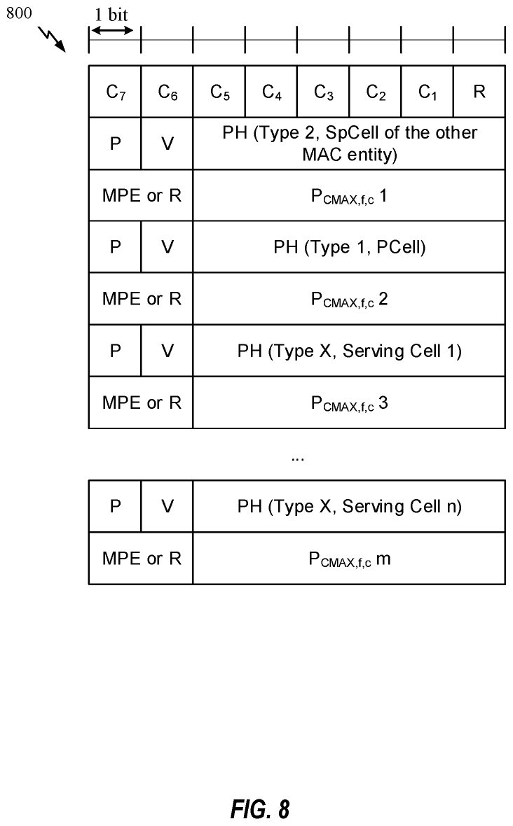

FIG. 6A depicts an example of PHR configuration for multiple TRPs. In particular, FIG. 6A depicts an IE comprising a first PHR configuration associated with a first TRP1, such as TRP 402a, and a second PHR configuration associated with a second TRP2, such as TRP 402b. In certain aspects, the first PHR configuration may apply to TRP 402a served in all cells. In certain aspects, the second PHR configuration may apply to TRP 402b served in all cells. Though only two PHR configurations are shown, it should be noted that the IE may include any number of PHR configurations.

FIG. 6B depicts an example of PHR configuration for multiple cells (e.g., serving cells). In particular, FIG. 6B depicts an IE comprising a first PHR configuration associated with a first cell 1, a second PHR configuration associated with a second cell 2, and a third PHR configuration associated with a third cell 3. Though only three PHR configurations are shown, it should be noted that the IE may include any number of PHR configurations. In this example, each PHR configuration is associated with the same TRP1, such as TRP 402a. In certain aspects, each of the cell specific PHR configurations may be configured under a servingcellconfig IE in an RRC message. In certain aspects, one or more of cells 1, 2, and 3 may be serving cells.

FIG. 6C depicts an example of PHR configuration for multiple TRP and cell (e.g., serving cell) combinations. FIG. 6C is similar to FIG. 6B, except that for each of cells 1-3 there is an additional PHR configuration for TRP2, such as TRP 402b.

In certain aspects, each PHR configuration of UE 404 is completely communication configuration specific, meaning that each PHR configuration for a given communication configuration includes separate values/configuration for all of the plurality of parameters of a PHR configuration. Therefore, the values of all of the plurality of parameters of one communication configuration of UE 404 can be different and independent of the values of the plurality of parameters of another communication configuration of UE 404.

In certain aspects, PHR configurations may be only partially communication configuration specific. For example, certain one or more parameters of the plurality of parameters of a PHR configuration may be common (e.g., have a common value) or shared across a plurality of communication configurations of UE 404 (e.g., indicated in a RRC message). For example, an RRC message may include only one value for each of the one or more parameters that are common, and the UE 404 may apply the value for that parameter for the PHR configuration for each communication configuration of the UE 404. In certain aspects, timer related parameters are shared across communication configurations of UE 404, such as periodic timer and prohibit timer. In certain such aspects, a timer is started once a PHR transmission is triggered for any communication configuration of UE 404.

In certain aspects of PHR configurations that are only partially communication configuration specific, certain one or more parameters may be communication configuration specific, and separately configured for different communication configurations of UE 404, such as in separate PHR configurations. In certain aspects, path loss reference signal parameters, such as power factor change may be communication configuration specific, such as because PL RS may be separately configured for different communication configurations of UE 404.

### Aspects Related to PHR Triggering

As discussed, UE 404 may receive a plurality of PHR configurations for a plurality of communication configurations of UE 404. Further, UE 404 may utilize the plurality of PHR configurations to determine when to trigger transmission of one or more PHRs.

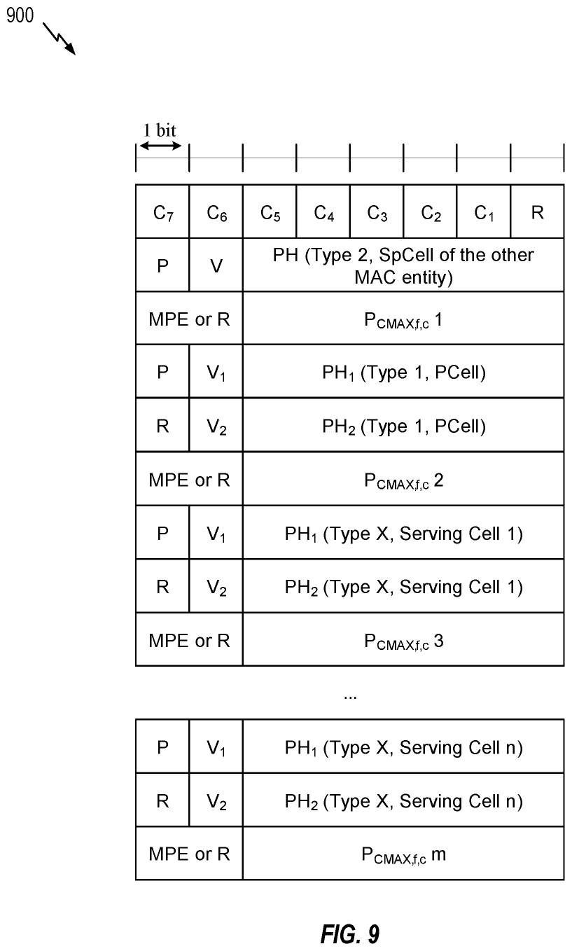

In certain aspects, UE 404 is configured to separately trigger and transmit (e.g., report) PHR for separate communication configurations (e.g., TRPs). For example, UE 404 may separately trigger PHR for a given communication configuration based on the plurality of parameters associated with a PHR configuration associated with the communication configuration. In certain aspects, the UE 404 may then report the PHR to a TRP associated with the communication configuration, or alternatively or additionally to another TRP. Example formats for the report of PHR are further described herein with respect to FIGS. 7-9. For example, UE 404 may be configured to transmit a first PHR based on the plurality of parameters of a first communication configuration and independent of the plurality of parameters of a second communication configuration; and transmit a second PHR based on the plurality of parameters of the second communication configuration and independent of the plurality of parameters of the first communication configuration.

In certain aspects of separate triggering of PHR for separate communication configurations, separate time and frequency resources are configured at UE 404 for reporting PHR triggered for separate communication configurations of UE 404. In certain aspects of separate triggering of PHR for separate communication configurations, the prohibit timer and/or power factor change are separately tracked at UE 404 for separate communication configurations, such that such condition of one communication configuration does not affect such condition of another communication configuration.

In certain aspects of separate triggering of PHR for separate TRPs, a PHR report only includes the actual or virtual PHR value among (e.g., serving) cells of UE 404 with a same TRP index as for which the PHR is triggered. In certain aspects, an actual PHR is based on the actual power headroom based on UE maximum transmit power and actual scheduled or occurring uplink transmission by UE 404. In certain aspects, a virtual PHR is based on the virtual power headroom based on UE maximum transmit power and a transmit power calculated assuming, for example, a smallest possible resource assignment (e.g., modulation coding scheme and format) for uplink transmission. In certain aspects, if multi-TRP PUSCH is not configured in a particular (e.g., serving) cell, then a cell-specific PHR report may be used for such cell regardless of which TRP index the PHR trigger is associated with.

In certain aspects, PHR triggering is performed based on the combination of the plurality of PHR configurations at UE 404. For example, UE 404 may be configured to transmit a first PHR based on the plurality of parameters of a first communication configuration and based on the plurality of parameters of a second communication configuration. Such PHR triggering may be referred to as single PHR triggering. In certain aspects, such PHR is triggered per medium access control (MAC) entity of UE 404. In certain aspects, for single PHR triggering, each communication configuration of UE 404 uses the same prohibit timer. In certain aspects, for single PHR triggering, each communication configuration of UE 404 may have a separately configured power factor change. Accordingly, in certain aspects of single PHR triggering, PHR may be triggered when the prohibit timer expires and any communication configuration is associated with a path loss change more than its associated power factor change.

In certain aspects, once a PHR is reported by UE 404, such as once a PHR MAC control element (MAC CE) is generated and transmitted (e.g., based on the values reported by a physical layer of UE 404), all PHR triggering parameters and all timers for the communication configurations whose PHR values have been reported are reset or cancelled.

### Aspects Related to PHR Reporting Format

In certain aspects, when PHR is triggered at UE 404, PHR is sent in a PHR MAC CE to TRP 402a and/or TRP 402b, such as via a first available PUSCH which could be dynamic or configured grant. In an example with respect to FIG. 5, the first available PUSCH may be associated with cell 1 at time 508 for a PHR triggered for TRP 402a in cell 1.

The PHR MAC CE may be, for example, a single entry PHR MAC CE or a multiple entry PHR MAC CE.

FIG. 7 depicts an example single entry PHR MAC CE 700. As shown, the P field indicates whether a maximum permitted exposure (MPE) of UE 404 is reported or not in the MPE or R field (e.g., if configured), and also indicates whether power backoff is applied or not due to power management. The MPE or R field indicates a reported MPE. The P_{CMAX} field indicates the UE maximum transmit power used for calculating the power headroom, which may only be present if it is for an actual transmission (e.g., an actual PHR). The PH field indicates the calculated power headroom.

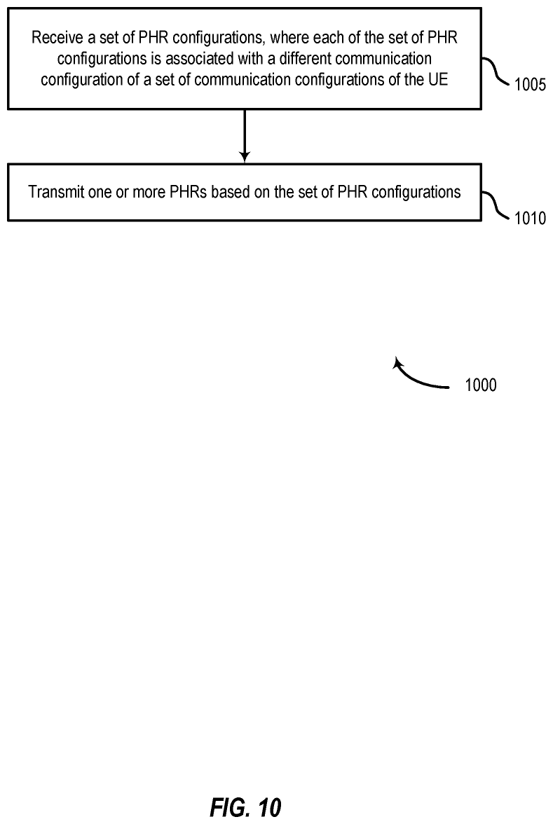

FIG. 8 depicts an example multiple entry PHR MAC CE 800. The multiple entry PHR MAC CE 800 includes some similar fields as single entry PHR MAC CE 700, as well as additional fields. In particular, each C field indicates the bitmap of the cells for which UE 404 is configured. Further an entry is included for each cell, meaning a PH can be reported per cell. The V field indicates whether the PH value for a particular entry is a virtual PHR or an actual PHR.

In certain aspects, UE 404 calculates one PHR value associated with the first PUSCH occasion (e.g., the earliest TB repetition that overlaps with the first time period in which the PUSCH that carriers the PHR MAC CE is transmitted). For example, with respect to FIG. 5, the first available PUSCH may be associated with cell 1 at time 508, such as for a PHR triggered for TRP 402a in cell 1. In certain aspects, PHR is reported for the TRP of one (e.g., serving) cell that is associated with the (e.g., first) transmission on the reported PHR MAC CE.

In certain aspects, UE 404 utilizes multiple entry PHR MAC CE 800 for PHR reporting. In certain aspects, UE 404 includes in multiple entry PHR MAC CE 800, multiple PH entries for a single time period/PUSCH occasion, such as time period 508 in FIG. 5. In certain aspects, if there is an actual uplink transmission (e.g., scheduled) by UE 404 in a cell that overlaps in time with the first uplink transmission by UE 404 (e.g., TB transmission in cell 1 at time 508 for which PHR is triggered), then regardless of whether that actual transmission is to a same TRP as the first uplink transmission or to a different TRP, the actual PHR for that cell is reported in PHR MAC CE 800. Further, if there is no actual uplink transmission by UE 404 to any TRP in a cell that UE 404 is configured to communicate that overlaps in time with the first uplink transmission by UE 404, then virtual PHR for that cell is reported in PHR MAC CE 800. For example, with respect to FIG. 5, if PHR is triggered and reported for cell 1 at time 508, then an actual PHR is included for cells 1, 2, and 4, and a virtual PHR is included for cell 3 in PHR MAC CE 800.

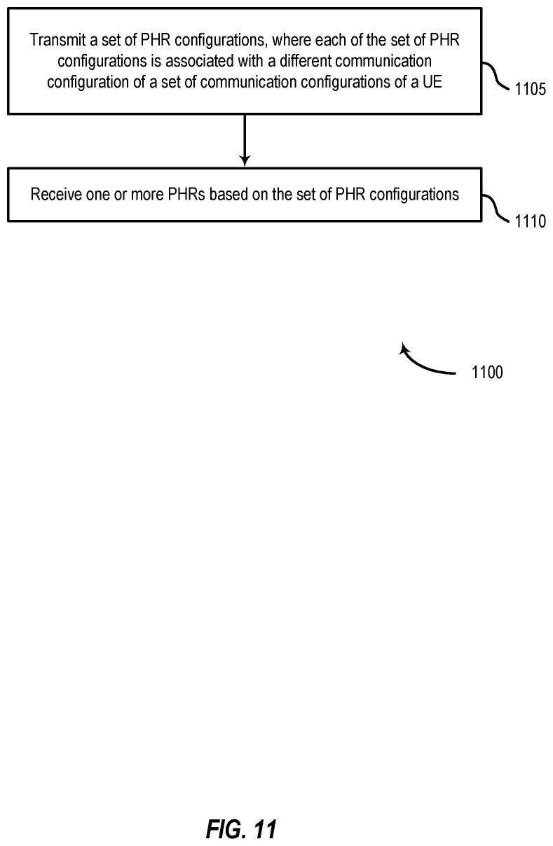

FIG. 9 depicts an example multiple entry PHR MAC CE 900 with multiple PHR per cell. The multiple entry PHR MAC CE 900 includes some similar fields as multiple entry PHR MAC CE 800, as well as an additional PH and associated V field for each cell for each additional TRP.

In certain aspects, UE 404 calculates two PHR values, one associated with a first PUSCH occasion for a first TRP, and one associated with a first PUSCH occasion for a second TRP. For example, with respect to FIG. 5, the first available PUSCH for TRP 1 may be associated with cell 1 at time 508, and the first available PUSCH for TRP 2 may be associated with cell 1 at time 510, such as for a PHR triggered for TRP 402a or TRP 402b in cell 1.

In certain aspects, UE 404 utilizes multiple entry PHR MAC CE 900 for PHR reporting. In certain aspects, UE 404 includes in multiple entry PHR MAC CE 900, multiple PH entries for two time periods/PUSCH occasions, such as time periods 508 and 510 in FIG. 5. In certain aspects, if there is an actual uplink transmission (e.g., scheduled) by UE 404 in a cell that overlaps in time with the first uplink transmission repetition to TRP1 by UE 404 (e.g., TB transmission in cell 1 at time 508), then regardless of whether that actual transmission is to a same TRP as the first uplink transmission or to a different TRP, the actual PHR for that cell is reported in PHR MAC CE 900.

Further, if there is an actual uplink transmission (e.g., scheduled) by UE 404 in a cell that overlaps in time with the second uplink transmission repetition to TRP2 by UE 404 (e.g., TB transmission in cell 1 at time 510), then regardless of whether that actual transmission is to a same TRP as the second uplink transmission or to a different TRP, the actual PHR for that cell is reported in PHR MAC CE 900.

Further, if there is no actual uplink transmission by UE 404 to any TRP in a cell that UE 404 is configured to communicate that overlaps in time with the first uplink transmission or the second uplink transmission by UE 404, then virtual PHR for that cell is reported in PHR MAC CE 900.

For example, with respect to FIG. 5, if PHR is triggered and reported for cell 1 at time 508, then an actual PHR is included for cells 1, 2, and 4 for time 508, an actual PHR is included for cells 1, 2, and 3 for time 510, a virtual PHR is included for cell 3 for time 508, and a virtual PHR is included for cell 4 for time 510 in PHR MAC CE 900.

In certain embodiments, in the example with respect to FIG. 5, the actual PHR value for cell 1 is included in the PH₁ field associated with cell 1 in PHR MAC CE 900 because there is an actual transmission for TRP1 in time 508 in cell 1. Further, the actual PHR value for cell 1 is included in the PH₂ field associated with cell 1 in PHR MAC CE 900 because there is an actual transmission for TRP2 in time 510 in cell 1. The actual PHR value for cell 2 is included in the PH₁ field associated with cell 2 in PHR MAC CE 900 because there is an actual transmission for TRP1 in time 508 in cell 2. A virtual PHR value for cell 2 is included in the PH₂ field associated with cell 2 in PHR MAC CE 900 because there is no actual transmission for TRP2 in cell 2 in either time 508 or time 510. The actual PHR value for cell 3 is included in the PH₁ field associated with cell 3 in PHR MAC CE 900 because there is an actual transmission for TRP1 in time 510 in cell 3. A virtual PHR value for cell 3 is included in the PH₂ field associated with cell 3 in PHR MAC CE 900 because there is no actual transmission for TRP2 in cell 3 in either time 508 or time 510. A virtual PHR value for cell 4 is included in the PH₁ field associated with cell 4 in PHR MAC CE 900 because there is no actual transmission for TRP1 in cell 4 in either time 508 or time 510. The actual PHR value for cell 4 is included in the PH₂ field associated with cell 4 in PHR MAC CE 900 because there is an actual transmission for TRP2 in time 508 in cell 4.

Accordingly, in certain embodiments, in PHR MAC CE 900, for each cell, there is a PH field for each TRP, such as a PH₁ for TRP1 and PH₂ for TRP2. Further, in certain embodiments, the PH field (e.g., PH₁) for a cell (e.g., cell 1) includes actual PHR if there is a transmission in the cell for the TRP associated with the PH field (e.g., TRP1) during a PUSCH occasion that overlaps in time with a PUSCH occasion that carries the PHR MAC CE 900 to any TRP (e.g., PUSCH occasions in time 508 or 510 as there is a PUSCH occasion carrying PHR MAC CE 900 for TRP1 in time 508 and a PUSCH occasion carrying PHR MAC CE 900 for TRP2 in time 510). Further, in certain embodiments, the PH field for a cell includes virtual PHR if there is no transmission in the cell for the TRP associated with the PH field during all PUSCH occasions that overlap in time with a PUSCH occasion that carries the PHR MAC CE 900 to any TRP.

### Example Methods

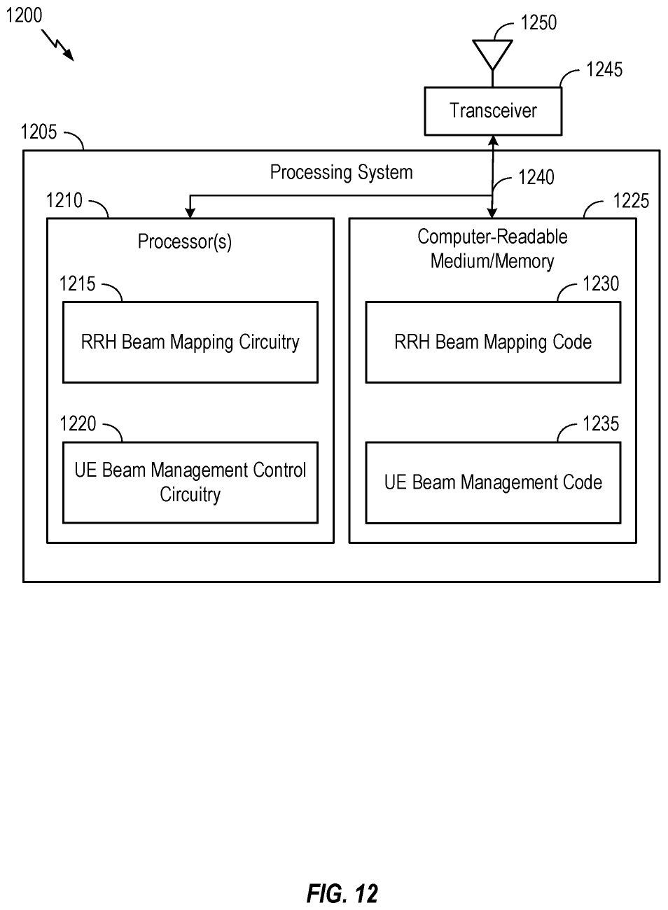

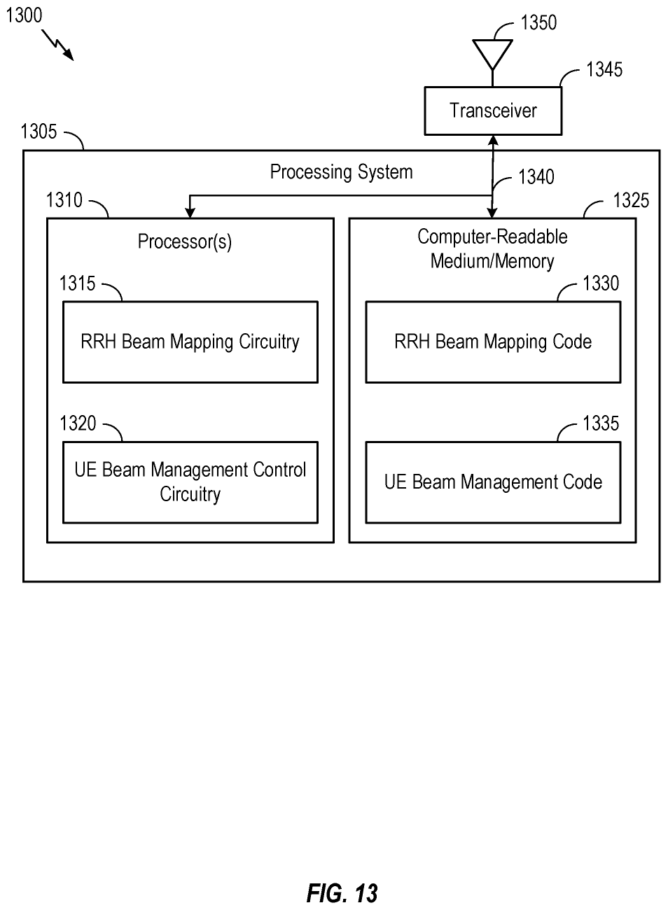

FIG. 10 shows an example of a method 1000 for power headroom reporting for uplink channel repetition according to aspects of the present disclosure. In some aspects, a user equipment, such as UE 104 of FIGS. 1 and 2, or processing system 1205 of FIG. 12, may perform the method 1000.

At operation 1005, the system receives a set of PHR configurations, where each of the set of PHR configurations is associated with a different communication configuration of a set of communication configurations of the UE. In some cases, the operations of this step refer to, or may be performed by, PHR configuration circuitry as described with reference to FIG. 12.

At operation 1010, the system transmits one or more PHRs based on the set of PHR configurations. In some cases, the operations of this step refer to, or may be performed by, PHR transmission circuitry as described with reference to FIG. 12.

In some aspects, the plurality of communication configurations of the UE comprise one or more of a plurality of sounding reference signal resource sets, a plurality of power control parameter sets, a plurality of transmit beams of the UE, a plurality of serving cells, a plurality of serving cell and sounding reference signal resource set combinations, a plurality of serving cell and power control parameter set combinations, or a plurality of serving cell and transmit beam combinations.

In some aspects, each of the plurality of PHR configurations comprises a plurality of parameters, and receiving the plurality of PHR configurations comprises receiving separate values for all of the plurality of parameters for each of the plurality of PHR configurations. In some aspects, the plurality of parameters comprise a periodic timer, a prohibit timer, and a power factor change.

In some aspects, transmitting the one or more PHRs based on the plurality of PHR configurations comprises transmitting a first PHR and a second PHR. In some aspects, the first PHR is transmitted based on the plurality of parameters of a first communication configuration and independently of the plurality of parameters of a second communication configuration, and the second PHR is transmitted based on the plurality of parameters of the second communication configuration and independently of the plurality of parameters of the first communication configuration.

In some aspects, each of the plurality of PHR configurations comprises a plurality of parameters. In some aspects, receiving the plurality of PHR configurations comprises receiving one or more separate values for one or more of the plurality of parameters for each of the plurality of PHR configurations and receiving at least one common value for at least one of the plurality of parameters for all of the plurality of PHR configurations. In some aspects, one or more of the plurality of parameters comprise a power factor change and the at least one of the plurality of parameters comprises a periodic timer and a prohibit timer. In some aspects, transmitting the one or more PHRs based on the plurality of PHR configurations comprises transmitting a first PHR based on the plurality of parameters of a first communication configuration and based on the plurality of parameters of a second communication configuration.

In some aspects, the plurality of PHR configurations are received in a RRC message.

In some aspects, transmitting the one or more PHRs comprises transmitting a plurality of PHRs in a single MAC CE, where the MAC CE is transmitted in a first uplink transmission occasion for transmitting a transport block. In some aspects, the plurality of PHRs comprise a first actual PHR associated with the first uplink transmission occasion and a second actual PHR associated with a second uplink transmission occasion for repeating transmission of the transport block occurring after the first uplink transmission occasion in time. In some aspects, the first uplink transmission occasion and the second uplink transmission occasion are associated with a first cell.

In some aspects, when there is a real transmission scheduled in a second cell that overlaps in time with the first uplink transmission occasion, the plurality of PHRs comprise a third actual PHR for the second cell for a time period of the first uplink transmission occasion. In some aspects, when there is not a real transmission scheduled in the second cell that overlaps in time with the first uplink transmission occasion, the plurality of PHRs comprise a first virtual PHR for the second cell for the time period of the first uplink transmission occasion. In some aspects, when there is a real transmission in the second cell that overlaps in time with the second uplink transmission occasion, the plurality of PHRs comprise a fourth actual PHR for the second cell for a time period of the second uplink transmission occasion. In some aspects, when there is not a real transmission in the second cell that overlaps in time with the second uplink transmission occasion, the plurality of PHRs comprise a second virtual PHR for the second cell for the time period of the second uplink transmission occasion.

In some aspects, transmitting the one or more PHRs comprises transmitting a first actual PHR in a MAC CE in an uplink transmission occasion for transmitting a transport block, where the uplink transmission occasion is associated with a first cell, where the MAC CE contains PHRs only for transport blocks overlapping in time with the uplink transmission occasion. In some aspects, when there is a real transmission scheduled in a second cell that overlaps in time with the uplink transmission occasion, the plurality of PHRs comprise a second actual PHR for the second cell for a time period of the uplink transmission occasion. In some aspects, when there is not a real transmission scheduled in the second cell that overlaps in time with the uplink transmission occasion, the plurality of PHRs comprise a virtual PHR for the second cell for the time period of the uplink transmission occasion.

FIG. 11 shows an example of a method 1100 for power headroom reporting for uplink channel repetition according to aspects of the present disclosure. In some aspects, a base station, such as base station 102 of FIGS. 1 and 2, or processing system 1305 of FIG. 13, may perform the method 1100.

At operation 1105, the system transmits a set of PHR configurations, where each of the set of PHR configurations is associated with a different communication configuration of a set of communication configurations of a UE. In some cases, the operations of this step refer to, or may be performed by, UE PHR configuration circuitry as described with reference to FIG. 13.

At operation 1110, the system receives one or more PHRs based on the set of PHR configurations. In some cases, the operations of this step refer to, or may be performed by, PHR reception circuitry as described with reference to FIG. 13.

In some aspects, the plurality of communication configurations of the UE comprise one or more of a plurality of sounding reference signal resource sets, a plurality of power control parameter sets, a plurality of transmit beams of the UE, a plurality of serving cells, a plurality of serving cell and sounding reference signal resource set combinations, a plurality of serving cell and power control parameter set combinations, or a plurality of serving cell and transmit beam combinations.

In some aspects, each of the plurality of PHR configurations comprises a plurality of parameters, and transmitting the plurality of PHR configurations comprises transmitting separate values for all of the plurality of parameters for each of the plurality of PHR configurations. In some aspects, the plurality of parameters comprise a periodic timer, a prohibit timer, and a power factor change.

In some aspects, receiving the one or more PHRs based on the plurality of PHR configurations comprises receiving a first PHR and a second PHR. In some aspects, the first PHR is received based on the plurality of parameters of a first communication configuration and independently of the plurality of parameters of a second communication configuration, and the second PHR is received based on the plurality of parameters of the second communication configuration and independently of the plurality of parameters of the first communication configuration.

In some aspects, each of the plurality of PHR configurations comprises a plurality of parameters. In some aspects, transmitting the plurality of PHR configurations comprises transmitting one or more separate values for one or more of the plurality of parameters for each of the plurality of PHR configurations and transmitting at least one common value for at least one of the plurality of parameters for all of the plurality of PHR configurations.

In some aspects, the one or more of the plurality of parameters comprise a power factor change and the at least one of the plurality of parameters comprises a periodic timer and a prohibit timer. In some aspects, receiving the one or more PHRs based on the plurality of PHR configurations comprises receiving a first PHR based on the plurality of parameters of a first communication configuration and based on the plurality of parameters of a second communication configuration.

In some aspects, the plurality of PHR configurations are transmitted in a RRC message.

In some aspects, receiving the one or more PHRs comprises receiving a plurality of PHRs in a single MAC CE, where the MAC CE is received in a first uplink transmission occasion for transmitting a transport block. In some aspects, the plurality of PHRs comprise a first actual PHR associated with the first uplink transmission occasion and a second actual PHR associated with a second uplink transmission occasion for repeating transmission of the transport block occurring after the first uplink transmission occasion in time. In some aspects, the first uplink transmission occasion and the second uplink transmission occasion are associated with a first cell.

In some aspects, when there is a real transmission scheduled in a second cell that overlaps in time with the first uplink transmission occasion, the plurality of PHRs comprise a third actual PHR for the second cell for a time period of the first uplink transmission occasion. In some aspects, when there is not a real transmission scheduled in the second cell that overlaps in time with the first uplink transmission occasion, the plurality of PHRs comprise a first virtual PHR for the second cell for the time period of the first uplink transmission occasion. In some aspects, when there is a real transmission in the second cell that overlaps in time with the second uplink transmission occasion, the plurality of PHRs comprise a fourth actual PHR for the second cell for a time period of the second uplink transmission occasion. In some aspects, when there is not a real transmission in the second cell that overlaps in time with the second uplink transmission occasion, the plurality of PHRs comprise a second virtual PHR for the second cell for the time period of the second uplink transmission occasion.

In some aspects, receiving the one or more PHRs comprises receiving a first actual PHR in a MAC CE in an uplink transmission occasion for transmitting a transport block, where the uplink transmission occasion is associated with a first cell and the MAC CE contains PHRs only for transport blocks overlapping in time with the uplink transmission occasion.

In some aspects, when there is a real transmission scheduled in a second cell that overlaps in time with the uplink transmission occasion, the plurality of PHRs comprise a second actual PHR for the second cell for a time period of the uplink transmission occasion. In some aspects, when there is not a real transmission scheduled in the second cell that overlaps in time with the uplink transmission occasion, the plurality of PHRs comprise a virtual PHR for the second cell for the time period of the uplink transmission occasion.

### Example Wireless Communication Devices

FIG. 12 depicts an example communications device 1200 that includes various components operable, configured, or adapted to perform operations for the techniques disclosed herein, such as the operations depicted and described with respect to FIG. 10. In some examples, communication device may be a user equipment 104 as described, for example with respect to FIGS. 1 and 2.

Communications device 1200 includes a processing system 1205 coupled to a transceiver 1245 (e.g., a transmitter and/or a receiver). Transceiver 1245 is configured to transmit (or send) and receive signals for the communications device 1200 via an antenna 1250, such as the various signals as described herein. Processing system 1205 may be configured to perform processing functions for communications device 1200, including processing signals received and/or to be transmitted by communications device 1200. A transceiver 1245 may communicate bi-directionally, via antennas 1250, wired, or wireless links as described above. For example, the transceiver 1245 may represent a wireless transceiver 1245 and may communicate bi-directionally with another wireless transceiver 1245. The transceiver 1245 may also include or be connected to a modem to modulate the packets and provide the modulated packets to for transmission, and to demodulate received packets. In some examples, transceiver 1245 may be tuned to operate at specified frequencies. For example, a modem can configure the transceiver 1245 to operate at a specified frequency and power level based on the communication protocol used by the modem.

Processing system 1205 may be configured to perform processing functions for communications device 1200, including processing signals received and/or to be transmitted by communications device 1200. Processing system 1205 includes one or more processors 1210 coupled to a computer-readable medium/memory 1225 via a bus 1240.

In some examples, one or more processors 1210 may include one or more intelligent hardware devices, (e.g., a general-purpose processing component, a digital signal processor (DSP), a central processing unit (CPU), a graphics processing unit (GPU), a microcontroller, an application specific integrated circuit (ASIC), a field programmable gate array (FPGA), a programmable logic device, a discrete gate or transistor logic component, a discrete hardware component, or any combination thereof). In some cases, the one or more processors 1210 are configured to operate a memory array using a memory controller. In other cases, a memory controller is integrated into the one or more processors 1210. In some cases, the one or more processors 1210 are configured to execute computer-readable instructions stored in a memory to perform various functions. In some aspects, one or more processors 1210 include special purpose components for modem processing, baseband processing, digital signal processing, or transmission processing.

In certain aspects, computer-readable medium/memory 1225 is configured to store instructions (e.g., computer-executable code) that when executed by the one or more processors 1210, cause the one or more processors 1210 to perform the operations illustrated in FIG. 10, or other operations for performing the various techniques discussed herein.

In one aspect, computer-readable medium/memory 1225 includes PHR configuration code 1230 and PHR transmission code 1235.

Examples of a computer-readable medium/memory 1225 include random access memory (RAM), read-only memory (ROM), solid state memory, a hard drive, a hard disk drive, etc. In some examples, computer-readable medium/memory 1225 is used to store computer-readable, computer-executable software including instructions that, when executed, cause a processor to perform various functions described herein. In some cases, computer-readable medium/memory 1225 contains, among other things, a basic input/output system (BIOS) which controls basic hardware or software operation such as the interaction with peripheral components or devices. In some cases, a memory controller operates memory cells. For example, the memory controller can include a row decoder, column decoder, or both. In some cases, memory cells within a memory store information in the form of a logical state.

Various components of communications device 1200 may provide means for performing the methods described herein, including with respect to FIG. 10.

In some examples, means for transmitting or sending (or means for outputting for transmission) may include the transceivers 254 and/or antenna(s) 252 of the user equipment 104 illustrated in FIG. 2 and/or transceiver 1245 and antenna 1250 of the communication device in FIG. 12.

In some examples, means for receiving (or means for obtaining) may include the transceivers 254 and/or antenna(s) 252 of the user equipment 104 illustrated in FIG. 2 and/or transceiver 1245 and antenna 1250 of the communication device in FIG. 12.

In one aspect, one or more processors 1210 includes PHR configuration circuitry 1215 and PHR transmission circuitry 1220.

According to some aspects, PHR configuration circuitry 1215 receives a set of PHR configurations, where each of the set of PHR configurations is associated with a different communication configuration of a set of communication configurations of the UE. In some examples, the set of communication configurations of the UE include one or more of a set of sounding reference signal resource sets, a set of power control parameter sets, a set of transmit beams of the UE, a set of serving cells, a set of serving cell and sounding reference signal resource set combinations, a set of serving cell and power control parameter set combinations, or a set of serving cell and transmit beam combinations.

According to some aspects, PHR transmission circuitry 1220 transmits one or more PHRs based on the set of PHR configurations.

In some examples, each of the set of PHR configurations includes a set of parameters, and receiving the set of PHR configurations includes receiving separate values for all of the set of parameters for each of the set of PHR configurations. In some examples, the set of parameters include a periodic timer, a prohibit timer, and a power factor change.

In some examples, transmitting the one or more PHRs based on the set of PHR configurations includes transmitting a first PHR and a second PHR. In some examples, the first PHR is transmitted based on the set of parameters of a first communication configuration and independently of the set of parameters of a second communication configuration, and the second PHR is transmitted based on the set of parameters of the second communication configuration and independently of the set of parameters of the first communication configuration. In some examples, each of the set of PHR configurations includes a set of parameters, and receiving the set of PHR configurations includes receiving one or more separate values for one or more of the set of parameters for each of the set of PHR configurations and receiving at least one common value for at least one of the set of parameters for all of the set of PHR configurations. In some examples, the one or more of the set of parameters include a power factor change and the at least one of the set of parameters includes a periodic timer and a prohibit timer. In some examples, transmitting the one or more PHRs based on the set of PHR configurations includes transmitting a first PHR based on the set of parameters of a first communication configuration and based on the set of parameters of a second communication configuration. In some examples, the set of PHR configurations are received in a RRC message.

In some examples, transmitting the one or more PHRs includes transmitting a set of PHRs in a single MAC CE, where the MAC CE is transmitted in a first uplink transmission occasion for transmitting a transport block. In some examples, the set of PHRs include a first actual PHR associated with the first uplink transmission occasion and a second actual PHR associated with a second uplink transmission occasion for repeating transmission of the transport block occurring after the first uplink transmission occasion in time. In some examples, the first uplink transmission occasion and the second uplink transmission occasion are associated with a first cell.

In some examples, when there is a real transmission scheduled in a second cell that overlaps in time with the first uplink transmission occasion, the set of PHRs include a third actual PHR for the second cell for a time period of the first uplink transmission occasion. In some examples, when there is not a real transmission scheduled in the second cell that overlaps in time with the first uplink transmission occasion, the set of PHRs include a first virtual PHR for the second cell for the time period of the first uplink transmission occasion. In some examples, when there is a real transmission in the second cell that overlaps in time with the second uplink transmission occasion, the set of PHRs include a fourth actual PHR for the second cell for a time period of the second uplink transmission occasion. In some examples, when there is not a real transmission in the second cell that overlaps in time with the second uplink transmission occasion, the set of PHRs include a second virtual PHR for the second cell for the time period of the second uplink transmission occasion.

In some examples, transmitting the one or more PHRs includes transmitting a first actual PHR in a MAC CE in an uplink transmission occasion for transmitting a transport block, where the uplink transmission occasion is associated with a first cell, where the MAC CE contains PHRs only for transport blocks overlapping in time with the uplink transmission occasion. In some examples, when there is a real transmission scheduled in a second cell that overlaps in time with the uplink transmission occasion, the set of PHRs include a second actual PHR for the second cell for a time period of the uplink transmission occasion. In some examples, when there is not a real transmission scheduled in the second cell that overlaps in time with the uplink transmission occasion, the set of PHRs include a virtual PHR for the second cell for the time period of the uplink transmission occasion.

Notably, FIG. 12 is just use example, and many other examples and configurations of communication device are possible.

FIG. 13 depicts an example communications device 1300 that includes various components operable, configured, or adapted to perform operations for the techniques disclosed herein, such as the operations depicted and described with respect to FIG. 11. In some examples, communication device may be a base station 102 as described, for example with respect to FIGS. 1 and 2.

Communications device 1300 includes a processing system 1305 coupled to a transceiver 1345 (e.g., a transmitter and/or a receiver). Transceiver 1345 is configured to transmit (or send) and receive signals for the communications device 1300 via an antenna 1350, such as the various signals as described herein. In some examples, transceiver 1345 is an example of, or includes aspects of, the corresponding element described with reference to FIG. 12.

Processing system 1305 may be configured to perform processing functions for communications device 1300, including processing signals received and/or to be transmitted by communications device 1300. Processing system 1305 includes one or more processors 1310 coupled to a computer-readable medium/memory 1325 via a bus 1340. In certain aspects, computer-readable medium/memory 1325 is configured to store instructions (e.g., computer-executable code) that when executed by the one or more processors 1310, cause the one or more processors 1310 to perform the operations illustrated in FIG. 11, or other operations for performing the various techniques discussed herein.

In some examples, computer-readable medium/memory 1325 is an example of, or includes aspects of, the corresponding element described with reference to FIG. 12. In one aspect, computer-readable medium/memory 1325 includes UE PHR configuration code 1330 and PHR reception code 1335.

Various components of communications device 1300 may provide means for performing the methods described herein, including with respect to FIG. 11.

In some examples, means for transmitting or sending (or means for outputting for transmission) may include the transceivers 232 and/or antenna(s) 234 of the base station 102 illustrated in FIG. 2 and/or transceiver 1345 and antenna 1350 of the communication device in FIG. 13.

In some examples, means for receiving (or means for obtaining) may include the transceivers 232 and/or antenna(s) 234 of the base station 102 illustrated in FIG. 2 and/or transceiver 1345 and antenna 1350 of the communication device in FIG. 13.

In some examples, one or more processors 1310 are examples of, or include aspects of, the corresponding element described with reference to FIG. 12. In one aspect, one or more processors 1310 includes UE PHR configuration circuitry 1315 and PHR reception circuitry 1320.

According to some aspects, UE PHR configuration circuitry 1315 transmits a set of PHR configurations, where each of the set of PHR configurations is associated with a different communication configuration of a set of communication configurations of a UE. In some examples, the set of communication configurations of the UE include one or more of a set of sounding reference signal resource sets, a set of power control parameter sets, a set of transmit beams of the UE, a set of serving cells, a set of serving cell and sounding reference signal resource set combinations, a set of serving cell and power control parameter set combinations, or a set of serving cell and transmit beam combinations.

According to some aspects, PHR reception circuitry 1320 receives one or more PHRs based on the set of PHR configurations.

In some examples, each of the set of PHR configurations includes a set of parameters, and transmitting the set of PHR configurations includes transmitting separate values for all of the set of parameters for each of the set of PHR configurations. In some examples, the set of parameters include a periodic timer, a prohibit timer, and a power factor change.

In some examples, receiving the one or more PHRs based on the set of PHR configurations includes receiving a first PHR and a second PHR. In some examples, the first PHR is received based on the set of parameters of a first communication configuration and independently of the set of parameters of a second communication configuration, and the second PHR is received based on the set of parameters of the second communication configuration and independently of the set of parameters of the first communication configuration. In some examples, each of the set of PHR configurations includes a set of parameters, and transmitting the set of PHR configurations includes transmitting one or more separate values for one or more of the set of parameters for each of the set of PHR configurations and transmitting at least one common value for at least one of the set of parameters for all of the set of PHR configurations. In some examples, the one or more of the set of parameters include a power factor change and the at least one of the set of parameters includes a periodic timer and a prohibit timer. In some examples, receiving the one or more PHRs based on the set of PHR configurations includes receiving a first PHR based on the set of parameters of a first communication configuration and based on the set of parameters of a second communication configuration. In some examples, the set of PHR configurations are transmitted in a RRC message.

In some examples, receiving the one or more PHRs includes receiving a set of PHRs in a single MAC CE, where the MAC CE is received in a first uplink transmission occasion for transmitting a transport block. In some examples, the set of PHRs include a first actual PHR associated with the first uplink transmission occasion and a second actual PHR associated with a second uplink transmission occasion for repeating transmission of the transport block occurring after the first uplink transmission occasion in time. In some examples, the first uplink transmission occasion and the second uplink transmission occasion are associated with a first cell.

In some examples, when there is a real transmission scheduled in a second cell that overlaps in time with the first uplink transmission occasion, the set of PHRs include a third actual PHR for the second cell for a time period of the first uplink transmission occasion. In some examples, when there is not a real transmission scheduled in the second cell that overlaps in time with the first uplink transmission occasion, the set of PHRs include a first virtual PHR for the second cell for the time period of the first uplink transmission occasion. In some examples, when there is a real transmission in the second cell that overlaps in time with the second uplink transmission occasion, the set of PHRs include a fourth actual PHR for the second cell for a time period of the second uplink transmission occasion. In some examples, when there is not a real transmission in the second cell that overlaps in time with the second uplink transmission occasion, the set of PHRs include a second virtual PHR for the second cell for the time period of the second uplink transmission occasion.

In some examples, receiving the one or more PHRs includes receiving a first actual PHR in a MAC CE in an uplink transmission occasion for transmitting a transport block, where the uplink transmission occasion is associated with a first cell and the MAC CE contains PHRs only for transport blocks overlapping in time with the uplink transmission occasion. In some examples, when there is a real transmission scheduled in a second cell that overlaps in time with the uplink transmission occasion, the set of PHRs include a second actual PHR for the second cell for a time period of the uplink transmission occasion. In some examples, when there is not a real transmission scheduled in the second cell that overlaps in time with the uplink transmission occasion, the set of PHRs include a virtual PHR for the second cell for the time period of the uplink transmission occasion.

Notably, FIG. 13 is just use example, and many other examples and configurations of communication device are possible.

### Example Clauses

Implementation examples are described in the following numbered clauses:

Clause 1: A method for wireless communications by a user equipment (UE), comprising: receiving a plurality of PHR configurations, where each of the plurality of PHR configurations is associated with a different communication configuration of a plurality of communication configurations of the UE; and transmitting one or more PHRs based on the plurality of PHR configurations.

Clause 2: The method of Clause 1, wherein the plurality of communication configurations of the UE comprise one or more of: a plurality of sounding reference signal resource sets, a plurality of power control parameter sets, a plurality of transmit beams of the UE, a plurality of serving cells, a plurality of serving cell and sounding reference signal resource set combinations, a plurality of serving cell and power control parameter set combinations, or a plurality of serving cell and transmit beam combinations.

Clause 3: The method of any one of Clauses 1-2, wherein each of the plurality of PHR configurations comprises a plurality of parameters, and wherein to receive the plurality of PHR configurations comprises to receive separate values for all of the plurality of parameters for each of the plurality of PHR configurations.

Clause 4: The method of Clause 3, wherein the plurality of parameters comprise a periodic timer, a prohibit timer, and a power factor change.

Clause 5: The method of Clause 3, wherein transmitting the one or more PHRs based on the plurality of PHR configurations comprises: transmitting a first PHR based on the plurality of parameters of a first communication configuration and independent of the plurality of parameters of a second communication configuration; and transmitting a second PHR based on the plurality of parameters of the second communication configuration and independent of the plurality of parameters of the first communication configuration.

Clause 6: The method of any one of Clauses 1-5, wherein each of the plurality of PHR configurations comprises a plurality of parameters, and wherein receiving the plurality of PHR configurations comprises: receiving one or more separate values for one or more of the plurality of parameters for each of the plurality of PHR configurations; and receiving at least one common value for at least one of the plurality of parameters for all of the plurality of PHR configurations.

Clause 7: The method of Clause 6, wherein the one or more of the plurality of parameters comprise a power factor change and the at least one of the plurality of parameters comprises a periodic timer and a prohibit timer.

Clause 8: The method of Clause 6, wherein transmitting the one or more PHRs based on the plurality of PHR configurations comprises: transmitting a first PHR based on the plurality of parameters of a first communication configuration and based on the plurality of parameters of a second communication configuration.

Clause 9: The method of any one of 1-8, wherein the plurality of PHR configurations are received in a RRC message.

Clause 10: The method of any one of Clauses 1-9, wherein transmitting the one or more PHRs comprises transmitting a plurality of PHRs in a single MAC CE, wherein the MAC CE is transmitted in a first uplink transmission occasion for transmitting a transport block, wherein the plurality of PHRs comprise a first actual PHR associated with the first uplink transmission occasion and a second actual PHR associated with a second uplink transmission occasion for repeating transmission of the transport block occurring after the first uplink transmission occasion in time.

Clause 11: The method of Clause 10, wherein the first uplink transmission occasion and the second uplink transmission occasion are associated with a first cell.

Clause 12: The method of Clause 11, wherein: when there is a real transmission scheduled in a second cell that overlaps in time with the first uplink transmission occasion, the plurality of PHRs comprise a third actual PHR for the second cell for a time period of the first uplink transmission occasion; when there is not a real transmission scheduled in the second cell that overlaps in time with the first uplink transmission occasion, the plurality of PHRs comprise a first virtual PHR for the second cell for the time period of the first uplink transmission occasion; when there is a real transmission in the second cell that overlaps in time with the second uplink transmission occasion, the plurality of PHRs comprise a fourth actual PHR for the second cell for a time period of the second uplink transmission occasion; and when there is not a real transmission in the second cell that overlaps in time with the second uplink transmission occasion, the plurality of PHRs comprise a second virtual PHR for the second cell for the time period of the second uplink transmission occasion.

Clause 13: The method of any one of Clauses 1-12, wherein transmitting the one or more PHRs comprises: transmitting a first actual PHR in a MAC CE in an uplink transmission occasion for transmitting a transport block, wherein the uplink transmission occasion is associated with a first cell, wherein the MAC CE contains PHRs only for transport blocks overlapping in time with the uplink transmission occasion.

Clause 14: The method of Clause 13, wherein: when there is a real transmission scheduled in a second cell that overlaps in time with the uplink transmission occasion, the plurality of PHRs comprise a second actual PHR for the second cell for a time period of the uplink transmission occasion; and when there is not a real transmission scheduled in the second cell that overlaps in time with the uplink transmission occasion, the plurality of PHRs comprise a virtual PHR for the second cell for the time period of the uplink transmission occasion.

Clause 15: A method for wireless communication by a base station, comprising: transmitting a plurality of PHR configurations, where each of the plurality of PHR configurations is associated with a different communication configuration of a plurality of communication configurations of a UE; and receiving one or more PHRs based on the plurality of PHR configurations.

Clause 16: The method of Clause 15, wherein the plurality of communication configurations of the UE comprise one or more of: a plurality of sounding reference signal resource sets, a plurality of power control parameter sets, a plurality of transmit beams of the UE, a plurality of serving cells, a plurality of serving cell and sounding reference signal resource set combinations, a plurality of serving cell and power control parameter set combinations, or a plurality of serving cell and transmit beam combinations.

Clause 17: The method of any one of Clauses 15-16, wherein each of the plurality of PHR configurations comprises a plurality of parameters, and wherein to transmit the plurality of PHR configurations comprises to transmit separate values for all of the plurality of parameters for each of the plurality of PHR configurations.

Clause 18: The method of Clause 17, wherein the plurality of parameters comprise a periodic timer, a prohibit timer, and a power factor change.

Clause 19: The method of Clause 17, wherein receiving the one or more PHRs based on the plurality of PHR configurations comprises: receiving a first PHR based on the plurality of parameters of a first communication configuration and independent of the plurality of parameters of a second communication configuration; and receiving a second PHR based on the plurality of parameters of the second communication configuration and independent of the plurality of parameters of the first communication configuration.

Clause 20: The method of any one of Clauses 15-19, wherein each of the plurality of PHR configurations comprises a plurality of parameters, and wherein to transmitting the plurality of PHR configurations comprises: transmitting one or more separate values for one or more of the plurality of parameters for each of the plurality of PHR configurations; and transmitting at least one common value for at least one of the plurality of parameters for all of the plurality of PHR configurations.

Clause 21: The method of Clause 20, wherein the one or more of the plurality of parameters comprise a power factor change and the at least one of the plurality of parameters comprises a periodic timer and a prohibit timer.

Clause 22: The method of Clause 20, wherein receiving the one or more PHRs based on the plurality of PHR configurations comprises: receiving a first PHR based on the plurality of parameters of a first communication configuration and based on the plurality of parameters of a second communication configuration.

Clause 23: The method of any one of Clauses 15-22, the plurality of PHR configurations are transmitted in a RRC message.

Clause 24: The method of any one of Clauses 15-23, wherein receiving the one or more PHRs comprises receiving a plurality of PHRs in a single MAC CE, wherein the MAC CE is received in a first uplink transmission occasion for transmitting a transport block, wherein the plurality of PHRs comprise a first actual PHR associated with the first uplink transmission occasion and a second actual PHR associated with a second uplink transmission occasion for repeating transmission of the transport block occurring after the first uplink transmission occasion in time.

Clause 25: The method of Clause 24, wherein the first uplink transmission occasion and the second uplink transmission occasion are associated with a first cell.

Clause 26: The method of Clause 25, wherein: when there is a real transmission scheduled in a second cell that overlaps in time with the first uplink transmission occasion, the plurality of PHRs comprise a third actual PHR for the second cell for a time period of the first uplink transmission occasion; when there is not a real transmission scheduled in the second cell that overlaps in time with the first uplink transmission occasion, the plurality of PHRs comprise a first virtual PHR for the second cell for the time period of the first uplink transmission occasion; when there is a real transmission in the second cell that overlaps in time with the second uplink transmission occasion, the plurality of PHRs comprise a fourth actual PHR for the second cell for a time period of the second uplink transmission occasion; and when there is not a real transmission in the second cell that overlaps in time with the second uplink transmission occasion, the plurality of PHRs comprise a second virtual PHR for the second cell for the time period of the second uplink transmission occasion.

Clause 27: The method of any one of Clauses 15-26, wherein receiving the one or more PHRs comprises receiving a first actual PHR in a MAC CE in an uplink transmission occasion for transmitting a transport block, wherein the uplink transmission occasion is associated with a first cell, wherein the MAC CE contains PHRs only for transport blocks overlapping in time with the uplink transmission occasion.

Clause 28: The method of Clause 27, wherein: when there is a real transmission scheduled in a second cell that overlaps in time with the uplink transmission occasion, the plurality of PHRs comprise a second actual PHR for the second cell for a time period of the uplink transmission occasion; and when there is not a real transmission scheduled in the second cell that overlaps in time with the uplink transmission occasion, the plurality of PHRs comprise a virtual PHR for the second cell for the time period of the uplink transmission occasion.

Clause 29: A processing system, comprising: a memory; and one or more processors coupled to the memory, the memory and the one or more processors configured to perform a method in accordance with any one of Clauses 1-28.

Clause 30: A processing system, comprising means for performing a method in accordance with any one of Clauses 1-28

Clause 31: A non-transitory computer-readable medium comprising computer-executable instructions that, when executed by one or more processors of a processing system, cause the processing system to perform a method in accordance with any one of Clauses 1-28.

Clause 32: A computer program product embodied on a computer-readable storage medium comprising code for performing a method in accordance with any one of Clauses 1-28.

### Additional Wireless Communication Network Considerations

The techniques and methods described herein may be used for various wireless communications networks (or wireless wide area network (WWAN)) and radio access technologies (RATs). While aspects may be described herein using terminology commonly associated with 3G, 4G, and/or 5G (e.g., 5G new radio (NR)) wireless technologies, aspects of the present disclosure may likewise be applicable to other communication systems and standards not explicitly mentioned herein.

5G wireless communication networks may support various advanced wireless communication services, such as enhanced mobile broadband (eMBB), millimeter wave (mmWave), machine type communications (MTC), and/or mission critical targeting ultra-reliable, low-latency communications (URLLC). These services, and others, may include latency and reliability requirements.

Returning to FIG. 1, various aspects of the present disclosure may be performed within the example wireless communication network 100.

In 3GPP, the term “cell” can refer to a coverage area of a NodeB and/or a narrowband subsystem serving this coverage area, depending on the context in which the term is used. In NR systems, the term “cell” and BS, next generation NodeB (gNB or gNodeB), access point (AP), distributed unit (DU), carrier, or transmission reception point may be used interchangeably. A BS may provide communication coverage for a macro cell, a pico cell, a femto cell, and/or other types of cells.

A macro cell may generally cover a relatively large geographic area (e.g., several kilometers in radius) and may allow unrestricted access by UEs with service subscription. A pico cell may cover a relatively small geographic area (e.g., a sports stadium) and may allow unrestricted access by UEs with service subscription. A femto cell may cover a relatively small geographic area (e.g., a home) and may allow restricted access by UEs having an association with the femto cell (e.g., UEs in a Closed Subscriber Group (CSG) and UEs for users in the home). A BS for a macro cell may be referred to as a macro BS. A BS for a pico cell may be referred to as a pico BS. A BS for a femto cell may be referred to as a femto BS, home BS, or a home NodeB.

Base stations 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., an S1 interface). Base stations 102 configured for 5G (e.g., 5G NR or Next Generation RAN (NG-RAN)) may interface with 5GC 190 through second backhaul links 184. Base stations 102 may communicate directly or indirectly (e.g., through the EPC 160 or 5GC 190) with each other over third backhaul links 134 (e.g., X2 interface). Third backhaul links 134 may generally be wired or wireless.

Small cell 102′ may operate in a licensed and/or an unlicensed frequency spectrum. When operating in an unlicensed frequency spectrum, the small cell 102′ may employ NR and use the same 5 GHz unlicensed frequency spectrum as used by the Wi-Fi AP 150. Small cell 102′, employing NR in an unlicensed frequency spectrum, may boost coverage to and/or increase capacity of the access network.

Some base stations, such as gNB 180 may operate in a traditional sub-6 GHz spectrum, in millimeter wave (mmWave) frequencies, and/or near mmWave frequencies in communication with the UE 104. When the gNB 180 operates in mmWave or near mmWave frequencies, the gNB 180 may be referred to as an mmWave base station.

The communication links 120 between base stations 102 and, for example, UEs 104, may be through one or more carriers. For example, base stations 102 and UEs 104 may use spectrum up to Y MHz (e.g., 5, 10, 15, 20, 100, 400, and other MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Wireless communications system 100 further includes a Wi-Fi access point (AP) 150 in communication with Wi-Fi stations (STAs) 152 via communication links 154 in, for example, a 2.4 GHz and/or 5 GHz unlicensed frequency spectrum. When communicating in an unlicensed frequency spectrum, the STAs 152/AP 150 may perform a clear channel assessment (CCA) prior to communicating in order to determine whether the channel is available.

Certain UEs 104 may communicate with each other using device-to-device (D2D) communication link 158. The D2D communication link 158 may use the DL/UL WWAN spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, FlashLinQ, WiMedia, Bluetooth, ZigBee, Wi-Fi based on the IEEE 802.11 standard, 4G (e.g., LTE), or 5G (e.g., NR), to name a few options.

EPC 160 may include a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and a Packet Data Network (PDN) Gateway 172. MME 162 may be in communication with a Home Subscriber Server (HSS) 174. MME 162 is the control node that processes the signaling between the UEs 104 and the EPC 160. Generally, MME 162 provides bearer and connection management.

Generally, user Internet protocol (IP) packets are transferred through Serving Gateway 166, which itself is connected to PDN Gateway 172. PDN Gateway 172 provides UE IP address allocation as well as other functions. PDN Gateway 172 and the BM-SC 170 are connected to the IP Services 176, which may include, for example, the Internet, an intranet, an IP Multimedia Subsystem (IMS), a PS Streaming Service, and/or other IP services.

BM-SC 170 may provide functions for MBMS user service provisioning and delivery. BM-SC 170 may serve as an entry point for content provider MBMS transmission, may be used to authorize and initiate MBMS Bearer Services within a public land mobile network (PLMN), and may be used to schedule MBMS transmissions. MBMS Gateway 168 may be used to distribute MBMS traffic to the base stations 102 belonging to a Multicast Broadcast Single Frequency Network (MBSFN) area broadcasting a particular service, and may be responsible for session management (start/stop) and for collecting eMBMS related charging information.

5GC 190 may include an Access and Mobility Management Function (AMF) 192, other AMFs 193, a Session Management Function (SMF) 194, and a User Plane Function (UPF) 195. AMF 192 may be in communication with a Unified Data Management (UDM) 196.

AMF 192 is generally the control node that processes the signaling between UEs 104 and 5GC 190. Generally, AMF 192 provides QoS flow and session management.

All user Internet protocol (IP) packets are transferred through UPF 195, which is connected to the IP Services 197, and which provides UE IP address allocation as well as other functions for 5GC 190. IP Services 197 may include, for example, the Internet, an intranet, an IP Multimedia Subsystem (IMS), a PS Streaming Service, and/or other IP services.

Returning to FIG. 2, various example components of BS 102 and UE 104 (e.g., the wireless communication network 100 of FIG. 1) are depicted, which may be used to implement aspects of the present disclosure.

At BS 102, a transmit processor 220 may receive data from a data source 212 and control information from a controller/processor 240. The control information may be for the physical broadcast channel (PBCH), physical control format indicator channel (PCFICH), physical hybrid ARQ indicator channel (PHICH), physical downlink control channel (PDCCH), group common PDCCH (GC PDCCH), and others. The data may be for the physical downlink shared channel (PDSCH), in some examples.

A medium access control (MAC)-control element (MAC-CE) is a MAC layer communication structure that may be used for control command exchange between wireless nodes. The MAC-CE may be carried in a shared channel such as a physical downlink shared channel (PDSCH), a physical uplink shared channel (PUSCH), or a physical sidelink shared channel (PSSCH).

Processor 220 may process (e.g., encode and symbol map) the data and control information to obtain data symbols and control symbols, respectively. Transmit processor 220 may also generate reference symbols, such as for the primary synchronization signal (PSS), secondary synchronization signal (SSS), PBCH demodulation reference signal (DMRS), and channel state information reference signal (CSI-RS).

Transmit (TX) multiple-input multiple-output (MIMO) processor 230 may perform spatial processing (e.g., precoding) on the data symbols, the control symbols, and/or the reference symbols, if applicable, and may provide output symbol streams to the modulators (MODs) in transceivers 232a-232t. Each modulator in transceivers 232a-232t may process a respective output symbol stream (e.g., for OFDM) to obtain an output sample stream. Each modulator may further process (e.g., convert to analog, amplify, filter, and upconvert) the output sample stream to obtain a downlink signal. Downlink signals from the modulators in transceivers 232a-232t may be transmitted via the antennas 234a-234t, respectively.

At UE 104, antennas 252a-252r may receive the downlink signals from the BS 102 and may provide received signals to the demodulators (DEMODs) in transceivers 254a-254r, respectively. Each demodulator in transceivers 254a-254r may condition (e.g., filter, amplify, downconvert, and digitize) a respective received signal to obtain input samples. Each demodulator may further process the input samples (e.g., for OFDM) to obtain received symbols.

MIMO detector 256 may obtain received symbols from all the demodulators in transceivers 254a-254r, perform MIMO detection on the received symbols if applicable, and provide detected symbols. Receive processor 258 may process (e.g., demodulate, deinterleave, and decode) the detected symbols, provide decoded data for the UE 104 to a data sink 260, and provide decoded control information to a controller/processor 280.

On the uplink, at UE 104, transmit processor 264 may receive and process data (e.g., for the physical uplink shared channel (PUSCH)) from a data source 262 and control information (e.g., for the physical uplink control channel (PUCCH) from the controller/processor 280. Transmit processor 264 may also generate reference symbols for a reference signal (e.g., for the sounding reference signal (SRS)). The symbols from the transmit processor 264 may be precoded by a TX MIMO processor 266 if applicable, further processed by the modulators in transceivers 254a-254r (e.g., for SC-FDM), and transmitted to BS 102.

At BS 102, the uplink signals from UE 104 may be received by antennas 234a-t, processed by the demodulators in transceivers 232a-232t, detected by a MIMO detector 236 if applicable, and further processed by a receive processor 238 to obtain decoded data and control information sent by UE 104. Receive processor 238 may provide the decoded data to a data sink 239 and the decoded control information to the controller/processor 240.

Memories 242 and 282 may store data and program codes for BS 102 and UE 104, respectively.

Scheduler 244 may schedule UEs for data transmission on the downlink and/or uplink.

5G may utilize orthogonal frequency division multiplexing (OFDM) with a cyclic prefix (CP) on the uplink and downlink. 5G may also support half-duplex operation using time division duplexing (TDD). OFDM and single-carrier frequency division multiplexing (SC-FDM) partition the system bandwidth into multiple orthogonal subcarriers, which are also commonly referred to as tones and bins. Each subcarrier may be modulated with data. Modulation symbols may be sent in the frequency domain with OFDM and in the time domain with SC-FDM. The spacing between adjacent subcarriers may be fixed, and the total number of subcarriers may be dependent on the system bandwidth. The minimum resource allocation, called a resource block (RB), may be 12 consecutive subcarriers in some examples. The system bandwidth may also be partitioned into subbands. For example, a subband may cover multiple RBs. NR may support a base subcarrier spacing (SCS) of 15 KHz and other SCS may be defined with respect to the base SCS (e.g., 30 kHz, 60 kHz, 120 kHz, 240 kHz, and others).

As above, FIGS. 3A-3D depict various example aspects of data structures for a wireless communication network, such as wireless communication network 100 of FIG. 1.

In various aspects, the 5G frame structure may be frequency division duplex (FDD), in which for a particular set of subcarriers (carrier system bandwidth), subframes within the set of subcarriers are dedicated for either DL or UL. 5G frame structures may also be time division duplex (TDD), in which for a particular set of subcarriers (carrier system bandwidth), subframes within the set of subcarriers are dedicated for both DL and UL. In the examples provided by FIGS. 3A and 3C, the 5G frame structure is assumed to be TDD, with subframe 4 being configured with slot format 28 (with mostly DL), where D is DL, U is UL, and X is flexible for use between DL/UL, and subframe 3 being configured with slot format 34 (with mostly UL). While subframes 3, 4 are shown with slot formats 34, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description below applies also to a 5G frame structure that is TDD.

Other wireless communication technologies may have a different frame structure and/or different channels. A frame (10 ms) may be divided into 10 equally sized subframes (1 ms). Each subframe may include one or more time slots. Subframes may also include mini-slots, which may include 7, 4, or 2 symbols. In some examples, each slot may include 7 or 14 symbols, depending on the slot configuration.

For example, for slot configuration 0, each slot may include 14 symbols, and for slot configuration 1, each slot may include 7 symbols. The symbols on DL may be cyclic prefix (CP) OFDM (CP-OFDM) symbols. The symbols on UL may be CP-OFDM symbols (for high throughput scenarios) or discrete Fourier transform (DFT) spread OFDM (DFT-s-OFDM) symbols (also referred to as single carrier frequency-division multiple access (SC-FDMA) symbols) (for power limited scenarios; limited to a single stream transmission).

The number of slots within a subframe is based on the slot configuration and the numerology. For slot configuration 0, different numerologies (μ) 0 to 5 allow for 1, 2, 4, 8, 16, and 32 slots, respectively, per subframe. For slot configuration 1, different numerologies 0 to 2 allow for 2, 4, and 8 slots, respectively, per subframe. Accordingly, for slot configuration 0 and numerology μ, there are 14 symbols/slot and 2μ slots/subframe. The subcarrier spacing and symbol length/duration are a function of the numerology. The subcarrier spacing may be equal to 2^{μ}×15 kHz, where μ is the numerology 0 to 5. As such, the numerology μ=0 has a subcarrier spacing of 15 kHz and the numerology μ=5 has a subcarrier spacing of 480 kHz. The symbol length/duration is inversely related to the subcarrier spacing. FIGS. 3A-3D provide an example of slot configuration 0 with 14 symbols per slot and numerology μ=2 with 4 slots per subframe. The slot duration is 0.25 ms, the subcarrier spacing is 60 kHz, and the symbol duration is approximately 16.67 μs.

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 3A, some of the REs carry reference (pilot) signals (RS) for a UE (e.g., UE 104 of FIGS. 1 and 2). The RS may include demodulation RS (DM-RS) (indicated as Rx for one particular configuration, where 100x is the port number, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 3B illustrates an example of various DL channels within a subframe of a frame. The physical downlink control channel (PDCCH) carries DCI within one or more control channel elements (CCEs), each CCE including nine RE groups (REGs), each REG including four consecutive REs in an OFDM symbol.

A primary synchronization signal (PSS) may be within symbol 2 of particular subframes of a frame. The PSS is used by a UE (e.g., 104 of FIGS. 1 and 2) to determine subframe/symbol timing and a physical layer identity.

A secondary synchronization signal (SSS) may be within symbol 4 of particular subframes of a frame. The SSS is used by a UE to determine a physical layer cell identity group number and radio frame timing.

Based on the physical layer identity and the physical layer cell identity group number, the UE can determine a physical cell identifier (PCI). Based on the PCI, the UE can determine the locations of the aforementioned DM-RS. The physical broadcast channel (PBCH), which carries a master information block (MIB), may be logically grouped with the PSS and SSS to form a synchronization signal (SS)/PBCH block. The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 3C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 3D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and HARQ ACK/NACK feedback. The PUSCH carries data, and may additionally be used to carry a buffer status report (BSR), a power headroom report (PHR), and/or UCI.

### Additional Considerations

The preceding description provides examples of power headroom reporting in communication systems. The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the generic principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The techniques described herein may be used for various wireless communication technologies, such as 5G (e.g., 5G NR), 3GPP Long Term Evolution (LTE), LTE-Advanced (LTE-A), code division multiple access (CDMA), time division multiple access (TDMA), frequency division multiple access (FDMA), orthogonal frequency division multiple access (OFDMA), single-carrier frequency division multiple access (SC-FDMA), time division synchronous code division multiple access (TD-SCDMA), and other networks. The terms “network” and “system” are often used interchangeably. A CDMA network may implement a radio technology such as Universal Terrestrial Radio Access (UTRA), cdma2000, and others. UTRA includes Wideband CDMA (WCDMA) and other variants of CDMA. cdma2000 covers IS-2000, IS-95 and IS-856 standards. A TDMA network may implement a radio technology such as Global System for Mobile Communications (GSM). An OFDMA network may implement a radio technology such as NR (e.g. 5G RA), Evolved UTRA (E-UTRA), Ultra Mobile Broadband (UMB), IEEE 802.11 (Wi-Fi), IEEE 802.16 (WiMAX), IEEE 802.20, Flash-OFDMA, and others. UTRA and E-UTRA are part of Universal Mobile Telecommunication System (UMTS). LTE and LTE-A are releases of UMTS that use E-UTRA. UTRA, E-UTRA, UMTS, LTE, LTE-A and GSM are described in documents from an organization named “3rd Generation Partnership Project” (3GPP). cdma2000 and UMB are described in documents from an organization named “3rd Generation Partnership Project 2” (3GPP2). NR is an emerging wireless communications technology under development.

The various illustrative logical blocks, modules and circuits described in connection with the present disclosure may be implemented or performed with a general purpose processor, a DSP, an ASIC, a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, a system on a chip (SoC), or any other such configuration.

If implemented in hardware, an example hardware configuration may comprise a processing system in a wireless node. The processing system may be implemented with a bus architecture. The bus may include any number of interconnecting buses and bridges depending on the specific application of the processing system and the overall design constraints. The bus may link together various circuits including a processor, machine-readable media, and a bus interface. The bus interface may be used to connect a network adapter, among other things, to the processing system via the bus. The network adapter may be used to implement the signal processing functions of the PHY layer. In the case of a user equipment (see FIG. 1), a user interface (e.g., keypad, display, mouse, joystick, touchscreen, biometric sensor, proximity sensor, light emitting element, and others) may also be connected to the bus. The bus may also link various other circuits such as timing sources, peripherals, voltage regulators, power management circuits, and the like, which are well known in the art, and therefore, will not be described any further. The processor may be implemented with one or more general-purpose and/or special-purpose processors. Examples include microprocessors, microcontrollers, DSP processors, and other circuitry that can execute software. Those skilled in the art will recognize how best to implement the described functionality for the processing system depending on the particular application and the overall design constraints imposed on the overall system.

If implemented in software, the functions may be stored or transmitted over as one or more instructions or code on a computer readable medium. Software shall be construed broadly to mean instructions, data, or any combination thereof, whether referred to as software, firmware, middleware, microcode, hardware description language, or otherwise. Computer-readable media include both computer storage media and communication media including any medium that facilitates transfer of a computer program from one place to another. The processor may be responsible for managing the bus and general processing, including the execution of software modules stored on the machine-readable storage media. A computer-readable storage medium may be coupled to a processor such that the processor can read information from, and write information to, the storage medium. In the alternative, the storage medium may be integral to the processor. By way of example, the machine-readable media may include a transmission line, a carrier wave modulated by data, and/or a computer readable storage medium with instructions stored thereon separate from the wireless node, all of which may be accessed by the processor through the bus interface. Alternatively, or in addition, the machine-readable media, or any portion thereof, may be integrated into the processor, such as the case may be with cache and/or general register files. Examples of machine-readable storage media may include, by way of example, RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. The machine-readable media may be embodied in a computer-program product.

A software module may comprise a single instruction, or many instructions, and may be distributed over several different code segments, among different programs, and across multiple storage media. The computer-readable media may comprise a number of software modules. The software modules include instructions that, when executed by an apparatus such as a processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a general register file for execution by the processor. When referring to the functionality of a software module below, it will be understood that such functionality is implemented by the processor when executing instructions from that software module.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The following claims are not intended to be limited to the aspects shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for” or, in the case of a method claim, the element is recited using the phrase “step for.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A user equipment (UE), comprising:
a memory; and
a processor coupled to the memory, the processor and the memory configured to:
receive a plurality of power headroom report (PHR) configurations, wherein each of the plurality of PHR configurations is associated with a different communication configuration of a plurality of communication configurations of the UE; and
transmit one or more PHRs based on the plurality of PHR configurations.

2. The UE of claim 1, wherein the plurality of communication configurations of the UE comprise one or more of:
a plurality of sounding reference signal resource sets;
a plurality of power control parameter sets;
a plurality of transmit beams of the UE;
a plurality of serving cells;
a plurality of serving cell and sounding reference signal resource set combinations;
a plurality of serving cell and power control parameter set combinations; or
a plurality of serving cell and transmit beam combinations.

3. The UE of claim 1, wherein each of the plurality of PHR configurations comprises a plurality of parameters, and wherein to receive the plurality of PHR configurations comprises to receive separate values for all of the plurality of parameters for each of the plurality of PHR configurations.

4. The UE of claim 3, wherein the plurality of parameters comprise a periodic timer, a prohibit timer, and a power factor change.

5. The UE of claim 3, wherein to transmit the one or more PHRs based on the plurality of PHR configurations comprises to:
transmit a first PHR based on the plurality of parameters of a first communication configuration and independent of the plurality of parameters of a second communication configuration; and
transmit a second PHR based on the plurality of parameters of the second communication configuration and independent of the plurality of parameters of the first communication configuration.

6. The UE of claim 1, wherein each of the plurality of PHR configurations comprises a plurality of parameters, and wherein to receive the plurality of PHR configurations comprises to:
receive one or more separate values for one or more of the plurality of parameters for each of the plurality of PHR configurations; and
receive at least one common value for at least one of the plurality of parameters for all of the plurality of PHR configurations.

7. The UE of claim 6, wherein:
the one or more of the plurality of parameters comprise a power factor change; and
the at least one of the plurality of parameters comprises a periodic timer and a prohibit timer.

8. The UE of claim 6, wherein to transmit the one or more PHRs based on the plurality of PHR configurations comprises to:
transmit a first PHR based on the plurality of parameters of a first communication configuration and based on the plurality of parameters of a second communication configuration.

9. The UE of claim 1, wherein the plurality of PHR configurations are received in a radio resource control (RRC) message.

10. The UE of claim 1, wherein to transmit the one or more PHRs comprises to transmit a plurality of PHRs in a single media access control (MAC) control element (CE), wherein the MAC CE is transmitted in a first uplink transmission occasion for transmitting a transport block, wherein the plurality of PHRs comprise a first actual PHR associated with the first uplink transmission occasion and a second actual PHR associated with a second uplink transmission occasion for repeating transmission of the transport block occurring after the first uplink transmission occasion in time.

11. The UE of claim 10, wherein the first uplink transmission occasion and the second uplink transmission occasion are associated with a first cell.

12. The UE of claim 11, wherein:
when there is a real transmission scheduled in a second cell that overlaps in time with the first uplink transmission occasion, the plurality of PHRs comprise a third actual PHR for the second cell for a time period of the first uplink transmission occasion;
when there is not a real transmission scheduled in the second cell that overlaps in time with the first uplink transmission occasion, the plurality of PHRs comprise a first virtual PHR for the second cell for the time period of the first uplink transmission occasion;
when there is a real transmission in the second cell that overlaps in time with the second uplink transmission occasion, the plurality of PHRs comprise a fourth actual PHR for the second cell for a time period of the second uplink transmission occasion; and
when there is not a real transmission in the second cell that overlaps in time with the second uplink transmission occasion, the plurality of PHRs comprise a second virtual PHR for the second cell for the time period of the second uplink transmission occasion.

13. The UE of claim 1, wherein to transmit the one or more PHRs comprises to transmit a first actual PHR in a media access control (MAC) control element (CE) in an uplink transmission occasion for transmitting a transport block, wherein the uplink transmission occasion is associated with a first cell, wherein the MAC CE contains PHRs only for transport blocks overlapping in time with the uplink transmission occasion.

14. The UE of claim 13, wherein:
when there is a real transmission scheduled in a second cell that overlaps in time with the uplink transmission occasion, the plurality of PHRs comprise a second actual PHR for the second cell for a time period of the uplink transmission occasion; and
when there is not a real transmission scheduled in the second cell that overlaps in time with the uplink transmission occasion, the plurality of PHRs comprise a virtual PHR for the second cell for the time period of the uplink transmission occasion.

15. A base station (BS), comprising:
a memory; and
a processor coupled to the memory, the processor and the memory configured to:
transmit a plurality of power headroom report (PHR) configurations, wherein each of the plurality of PHR configurations is associated with a different communication configuration of a plurality of communication configurations of a user equipment (UE); and
receive one or more PHRs based on the plurality of PHR configurations.

16. The BS of claim 15, wherein the plurality of communication configurations of the UE comprise one or more of:
a plurality of sounding reference signal resource sets;
a plurality of power control parameter sets;
a plurality of transmit beams of the UE;
a plurality of serving cells;
a plurality of serving cell and sounding reference signal resource set combinations;
a plurality of serving cell and power control parameter set combinations; or
a plurality of serving cell and transmit beam combinations.

17. The BS of claim 15, wherein each of the plurality of PHR configurations comprises a plurality of parameters, and wherein to transmit the plurality of PHR configurations comprises to transmit separate values for all of the plurality of parameters for each of the plurality of PHR configurations.

18. The BS of claim 17, wherein the plurality of parameters comprise a periodic timer, a prohibit timer, and a power factor change.

19. The BS of claim 17, wherein to receive the one or more PHRs based on the plurality of PHR configurations comprises to:
receive a first PHR based on the plurality of parameters of a first communication configuration and independent of the plurality of parameters of a second communication configuration; and
receive a second PHR based on the plurality of parameters of the second communication configuration and independent of the plurality of parameters of the first communication configuration.

20. The BS of claim 15, wherein each of the plurality of PHR configurations comprises a plurality of parameters, and wherein to transmit the plurality of PHR configurations comprises to:
transmit one or more separate values for one or more of the plurality of parameters for each of the plurality of PHR configurations; and
transmit at least one common value for at least one of the plurality of parameters for all of the plurality of PHR configurations.

21. The BS of claim 20, wherein:
the one or more of the plurality of parameters comprise a power factor change; and
the at least one of the plurality of parameters comprises a periodic timer and a prohibit timer.

22. The BS of claim 20, wherein to receive the one or more PHRs based on the plurality of PHR configurations comprises to:
receive a first PHR based on the plurality of parameters of a first communication configuration and based on the plurality of parameters of a second communication configuration.

23. The BS of claim 15, wherein the plurality of PHR configurations are transmitted in a radio resource control (RRC) message.

24. The BS of claim 15, wherein to receive the one or more PHRs comprises to receive a plurality of PHRs in a single media access control (MAC) control element (CE), wherein the MAC CE is received in a first uplink transmission occasion for transmitting a transport block, wherein the plurality of PHRs comprise a first actual PHR associated with the first uplink transmission occasion and a second actual PHR associated with a second uplink transmission occasion for repeating transmission of the transport block occurring after the first uplink transmission occasion in time.

25. The BS of claim 24, wherein the first uplink transmission occasion and the second uplink transmission occasion are associated with a first cell.

26. The BS of claim 25, wherein:
when there is a real transmission scheduled in a second cell that overlaps in time with the first uplink transmission occasion, the plurality of PHRs comprise a third actual PHR for the second cell for a time period of the first uplink transmission occasion;
when there is not a real transmission scheduled in the second cell that overlaps in time with the first uplink transmission occasion, the plurality of PHRs comprise a first virtual PHR for the second cell for the time period of the first uplink transmission occasion;
when there is a real transmission in the second cell that overlaps in time with the second uplink transmission occasion, the plurality of PHRs comprise a fourth actual PHR for the second cell for a time period of the second uplink transmission occasion; and
when there is not a real transmission in the second cell that overlaps in time with the second uplink transmission occasion, the plurality of PHRs comprise a second virtual PHR for the second cell for the time period of the second uplink transmission occasion.

27. The BS of claim 15, wherein to receive the one or more PHRs comprises to receive a first actual PHR in a media access control (MAC) control element (CE) in an uplink transmission occasion for transmitting a transport block, wherein the uplink transmission occasion is associated with a first cell, wherein the MAC CE contains PHRs only for transport blocks overlapping in time with the uplink transmission occasion.

28. The BS of claim 27, wherein:
when there is a real transmission scheduled in a second cell that overlaps in time with the uplink transmission occasion, the plurality of PHRs comprise a second actual PHR for the second cell for a time period of the uplink transmission occasion; and
when there is not a real transmission scheduled in the second cell that overlaps in time with the uplink transmission occasion, the plurality of PHRs comprise a virtual PHR for the second cell for the time period of the uplink transmission occasion.

29. A method for wireless communication by a user equipment (UE), the method comprising:
receiving a plurality of power headroom report (PHR) configurations, wherein each of the plurality of PHR configurations is associated with a different communication configuration of a plurality of communication configurations of the UE; and
transmitting one or more PHRs based on the plurality of PHR configurations.

30. A non-transitory computer readable storage medium comprising instructions that, when executed by one or more processors of a user equipment (UE), cause the UE to perform operations comprising:
receiving a plurality of power headroom report (PHR) configurations, wherein each of the plurality of PHR configurations is associated with a different communication configuration of a plurality of communication configurations of the UE; and
transmitting one or more PHRs based on the plurality of PHR configurations.
